(19) United States
(12) Patent Application Publication
(10) Pub. No.: US 2003/0216993 A1
(43) Pub. Date: Nov. 20, 2003

(54) System, method and computer program product for providing online service contract negotiation service

(76) Inventors: Eyal Goldwerger, New York, NY (US); David Kidd, Florence, KY (US)

Correspondence Address: VENABLE, BAETJER, HOWARD AND CIVILETTI, LLP, P.O. BOX 34385, WASHINGTON, DC, 20043-9998, US

(21) Appl. No.: 10/305,373

(22) Filed: Nov. 27, 2002

Related U.S. Application Data
(63) Continuation-in-part of application No. 09/665,291, filed on Sep. 20, 2000.
(60) Provisional application No. 60/154,773, filed on Sep. 20, 1999.

(51) Int. Cl. G06F 17/60

(52) U.S. Cl. 705/37

(57) ABSTRACT

A system, method, and computer program product for negotiating a service contract including receiving a tender line item from a shipper and an offer from a carrier, providing online viewing access to the tender line item and the offer, receiving a designation of a selected offer associated with the tender line item, and communicating the designation.

### CROSS-REFERENCE OF OTHER APPLICATIONS

This application is a Continuation In Part (CIP) of U.S. patent application Ser. No. 09/665,291 filed Sep. 20, 2000 (Attorney Docket No. 30485-181800), which in turn claims priority to U.S. Provisional Patent Application No. 60/154,773, titled “Online Shipping Exchange” and filed Sep. 20, 1999. The contents of these related applications are incorporated herein by reference in their entirety.

### FIELD OF THE INVENTION

The present invention generally relates to contract negotiation. Specifically, the invention relates to service contract negotiation. More specifically, the present invention relates to service contract negotiation for connecting shippers and transportation service providers.

### BACKGROUND OF THE INVENTION

The present worldwide commodity shipping market includes hundreds of transportation service providers, including, e.g., ocean carriers and tens of thousands of intermediaries, including freight forwarders and non-vessel-operating-common-carriers (NVOCCs). Conventionally, these transportation service providers (referred to hereinafter as “carriers”) must compete fiercely to identify and keep in touch with potential shippers such as, e.g., importers, exporters and shipping associations (referred to hereinafter as “shippers”). Many shippers work with carriers based on connections and personal relationships. On the other hand, many shippers do not have ready and easy access to most carriers. These shippers must struggle to identify appropriate carriers in order to have a competitive base from which to choose a carrier.

Commodity shipping markets worldwide are constantly shifting towards more open competitive and less regulated environments. For example, the Ocean Shipping Reform Act (OSRA), which became effective May 1, 1999 in the U.S.A., is an important legislative step towards a more deregulated environment. One of the key elements of OSRA includes a stipulation that cancels the obligation to publicly file with the regulatory agency the negotiated rates for service contracts (service contracts are agreements generally between carriers and shippers covering repeated shipments over a certain term). The direct consequence of no longer requiring public regulatory filings is the creation of a new competitive environment for the negotiation of service contract rates in the U.S.A.

The introduction of the Internet and the World-Wide-Web (“WWW”) into the business world provides a platform that is ideally suited for taking advantage of this newly competitive environment. However, the commodity shipping market conventionally lacks a central system that fully takes advantage of the Internet and the WWW to provide a business-to-business marketplace for shippers and carriers. No system or method exists that enables shippers and carriers to communicate and evaluate each other's proposals. No system or method exists which enables a carrier to evaluate specific shipments or service contracts based on the commodity shipped, the shipper's booking frequency, the trade route and/or other shipment specifications made by the shipper. Likewise, no system or method exists which enables a shipper to evaluate a carrier's offers (quotations) based on rate, services included in the rate (“price components”), transit time or logistics solution, the carrier's quality rating or the carrier's brand recognition. Moreover, no system or method exists which allows monitoring the actual adherence to terms agreed to by shipper and carrier. Conventional solutions do not provide for monitoring terms such as, e.g., the carrier's performance as well as the shipper's provision of agreed-to cargos.

### SUMMARY OF THE INVENTION

An exemplary embodiment of the present invention includes a system, method and computer program product for creating an online business to business exchange, ultimately resulting in a service contract, for shipments. In an exemplary embodiment, the method includes specifying shipping requirements by a shipper, for example, in the form of a tender line item that can include information that describes a requested shipping service including, e.g., an origin, destination, container size, and, optionally, a commodity to be shipped. The method can further include initiating a negotiation process for the requested shipping service as described by the shipping requirements, where the negotiation process allows carriers to provide offers in an attempt to secure a service contract to perform the requested shipping service associated with the tender line item provided by the shipper.

An exemplary embodiment of the present invention includes receiving one or more tender line items from a shipper and storing the tender line items in a tender database. Each of the tender line items may include an origin, a destination and a container size of a container. The tender line items may also include a commodity, volume information for a period of time, a route, and a type of service required. The method can also include providing online viewing access to the tender database to one or more carriers, allowing the carriers to respond to the tender line items with offers, and storing the offers in an offer database. Each offer may include a price and a route. An offer may also include a time frame. It is to be appreciated by one skilled in the art that a route may comprise a method of service, a quality of service, or a mode of transportation. A mode of transportation may include ocean transport, land transport or air transport. Land transport may include rail transport, truck transport or barge transport. According to an exemplary embodiment of the present invention, the shippers can be provided online viewing access of all offers submitted to the offer database by the carriers. Each shipper can designate one or more winning carriers for an awarded line item and the winning carriers are notified. The winning carriers may be notified through electronic means including, for example, an online application, an email, a facsimile, a handheld messaging device, or a message.

The designation of the awarded line items may also be communicated to designated users of information including, e.g., personnel from warehouses, personnel from shipping sites, personnel from courier sites, personnel from manufacturing plants and selected third parties, such as, e.g., freight forwarders, consolidators, third party logistics and accountants.

According to an exemplary embodiment of the present invention, the method may also include monitoring for exceptions including, e.g., tracking actual bookings and comparing the actual bookings to the designated awarded line items. The method may also include identifying a variance between the actual bookings and the final designation of awarded line items and reporting any such variances to appropriate parties at the shipper. This notification can take place through a number of ways including, for example, an online application, an email, a facsimile, a handheld messaging device, or a message. The method may also include receiving a confirmation that the courier has completed appropriate regulatory actions, such as filing the required tariffs, for example.

An exemplary embodiment of the present invention can include an online shipping service contract negotiation service provider including, e.g., a server that hosts the online negotiation, having a secondary storage device and coupled to a network. The server can be accessed from the network by, e.g., a user machine enabling user access to the server. The user machine can include, e.g., a computer, a workstation, a communication device, or other computing device including a processor, memory, a secondary storage device, a display, an input device and a connection to the network such as, e.g., a network interface card (NIC). The user machine can access the server through the network. A plurality of screens, that are supported by the server can be displayed and presented on the display. For example, a create-a-tender-line item screen or a graphical user interface (GUI) can enable a first user (e.g. a shipper) to enter shipping requirements to create a tender line item, where shipping requirements can include information that describes a requested shipping service. The create-a-tender-line item screen can include, e.g., sections for entering the shipping requirements. Specifically, the sections can include an origin section, a destination section, and a container size section. The create-a-tender-line-item screen can further include, e.g., optional sections for entering optional information such as a commodity. The create-a-tender-line-item screen can further include, e.g., a second screen that enables a second user (e.g. a carrier) to submit an offer. The second screen can, in addition to prompting for receiving input can also display information such as, e.g., the shipping requirements for the tender line item.

Another exemplary embodiment includes a method operative at a server for creating a business to business exchange for shipments, the method including displaying a list of tender line items for shipping services that are available for bidding, providing information about each of the tender line items, including, for example, an origin, destination, and container size, storing an offer placed on one of the tender line items, where the offer includes price components and displaying the offer so that a shipper may evaluate the bid.

An exemplary embodiment of the present invention may also include storing and displaying booked, won and other historical tender line items or offers, the stored information being made available to be utilized in evaluating current tender line items or offers.

An exemplary embodiment of the present invention sets forth a system, method, and computer program product for negotiating a service contract online via a service contract negotiation online service provider, including the steps of receiving one or more tender line items from a shipper and storing the one or more tender line items in a tender database, providing online viewing access of the tender database to one or more carriers, receiving an offer from each of the one or more carriers and storing offers received from the one or more carriers in an offer database, providing online viewing access of the offers received from the offer database to the shipper, receiving one or more final designations of awarded line items from the shipper designating one or more winning carriers, and communicating the one or more final designations of awarded line items corresponding to one or more awarded service contracts.

In another exemplary embodiment, the method can include each of the one or more tender line items can include an origin, a destination, and a container size of a container. Each of the one or more tender line items may also include a route or a commodity, according to yet another exemplary embodiment of the invention. According to still another exemplary embodiment, the container can be an ocean container.

In yet another exemplary embodiment of the present invention, the method may also include the steps of, receiving a list of one or more tentative award carriers designated by the shipper, and receiving at least one revised offer from the one or more tentative award carriers.

In another exemplary embodiment, the method may also include filtering of the online views, provided to the one or more carriers, of the one or more tender line items.

In yet another exemplary embodiment of the invention, the one or more tender line items may also include an origin, a destination, a container size, a commodity, volume information for a period of time, a route, or a type of service.

According to another exemplary embodiment, the method may include an offer which includes a price or a route. The method may also include an offer including a time frame, according to another exemplary embodiment of the invention.

According to yet another exemplary embodiment of the method according to the present invention, the route may include a method of service, a quality of service, or a mode of transportation.

In another exemplary embodiment, the method can include a mode of transportation which includes ocean transport, land transport, or air transport. In yet another exemplary embodiment, the land transport can include rail transport, truck transport, or barge transport, for example.

According to yet another exemplary embodiment of the present invention, the method can also include communicating the one or more final designations of awarded line items corresponding to one or more awarded service contracts by communicating the one or more final designations of awarded line items to designated users of information including personnel from warehouses, personnel from shipping sites, personnel from carrier sites, personnel from manufacturing plants, or selected third parties. In another exemplary embodiment, the third parties can include freight forwarders, consolidators, third party logistics, or accountants.

In yet another embodiment, the method can also include monitoring for exceptions including tracking actual bookings, comparing actual bookings to the one or more final designations of awarded line items, identifying a variance between the actual bookings and the one or more final designations of awarded line items, and reporting the variance.

In another exemplary embodiment, the method can include comparing actual bookings to the one or more final designations of awarded line items by comparing a booked container quantity to a committed container quantity.

In yet another exemplary embodiment, the method can include the step of identifying a variance between the actual bookings and the one or more final designations of awarded line items, including determining whether the variance exceeds a variance threshold.

According to yet another exemplary embodiment of the invention, the method can include reporting the variance by notifying appropriate parties at shipper of the variance. In another exemplary embodiment, the appropriate parties may be notified through electronic means. In yet another exemplary embodiment, the electronic means can include an online application, an email, a facsimile, a computing device, a communications device, a handheld messaging device, or a message.

In another exemplary embodiment of the present invention, the method may also include receiving confirmation that that one or more winning carriers has completed appropriate regulatory actions.

Another exemplary embodiment of the present invention sets forth a system, method, and computer program product for negotiating a service contract including receiving a tender line item from a shipper and an offer from a carrier, providing online viewing access to the tender line item and the offer, receiving a designation of a selected offer associated with the tender line item, and communicating the designation.

In another exemplary embodiment, the method can include reporting actual volume of cargo moved against the service contract.

In yet another exemplary embodiment, the method can include reporting actual line items moved in the service contract.

In still another exemplary embodiment, the method can include reporting actual line items moved outside the service contract.

In another exemplary embodiment, the method can include reporting actual service performance of carriers against agreed upon service performance.

In yet another exemplary embodiment, the method can include providing an automated booking process by allowing shipper to place a booking against a contract line item of the service contract.

### BRIEF DESCRIPTION OF THE DRAWINGS

The present invention will be described with reference to the accompanying figures, wherein:

FIG. 1 is a diagram illustrating the operation of a known unautomated negotiation method;

FIG. 2 is a diagram illustrating an exemplary embodiment of a service contract negotiation service provider interacting with one or more shippers and carriers according to the present invention;

FIG. 3 is a diagram illustrating a second exemplary embodiment of a service contract negotiation service provider interacting with one or more shippers and carriers according to the present invention;

FIG. 4 is a diagram illustrating an exemplary environment in which an exemplary embodiment of the present invention may operate;

FIG. 5 is a diagram illustrating an exemplary report produced by a carrier analysis module according to an exemplary embodiment of the present invention;

FIG. 6 is a diagram illustrating an exemplary report produced by a shipper analysis module according to an exemplary embodiment of the present invention;

FIG. 7 is a diagram illustrating an exemplary report produced by a monitor/alert module according to an exemplary embodiment of the present invention;

FIGS. 8a-8c illustrate various exemplary registration screens according to an exemplary embodiment of the present invention;

FIGS. 9a-9s illustrate exemplary embodiments of various screens accessed by shippers using an exemplary embodiment of the present invention;

FIGS. 10a-10m illustrate exemplary embodiments of various screens accessed by service providers using an exemplary embodiment of the present invention;

FIG. 11 illustrates an exemplary embodiment of a screen accessed by non-vessel operating common-carriers (NVOCCs) using an exemplary embodiment of the present invention; and

FIGS. 12a-12e illustrates exemplary embodiments of various screens accessed by Account Managers using an exemplary embodiment of the present invention.

### DETAILED DESCRIPTION OF THE INVENTION

A preferred embodiment of the present invention appears below. It will be apparent to one skilled in the art that the detailed description of the invention disclosed herein comprises exemplary embodiments of the invention and that modifications may be made without departing from the teachings of the invention. Accordingly, the embodiments disclosed herein should be understood to only be representative and that the scope of the present invention should only be limited by the claims included herein and their equivalents.

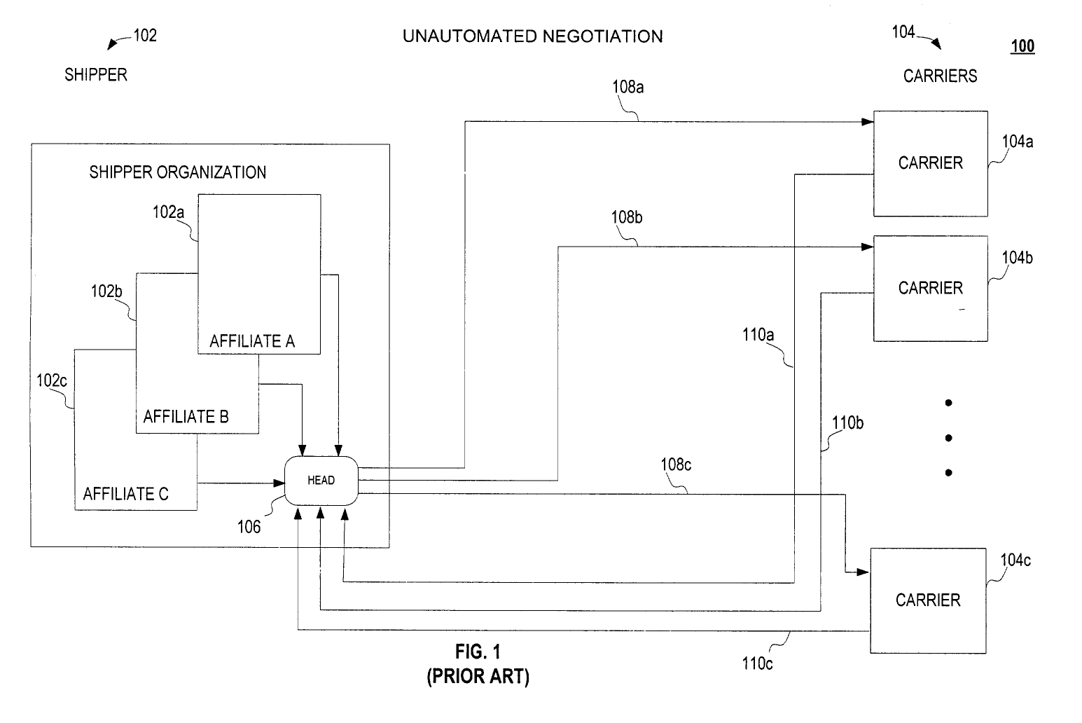

FIG. 1 is a diagram 100 conceptually illustrating a typical unautomated negotiation method for an exemplary shipper 102 and one or more carriers 104. Shipper 102 in an exemplary embodiment is a shipping organization with affiliates 102a, 102b, and 102c. Conventionally, a head of operations 106 initiates a tender by requesting each of the affiliates 102a-102c to globally submit a forecast of need. Each affiliate 102a-102c may independently send tender line items to the head of operations 106 of the shipper 102 as illustrated. The format of the tender line items may vary from one affiliate 102a-102c to the next. The head of operations 106 then compiles each of the tender line items into a common format and forwards the requests to carriers 104a, 104b, and 104c as shown by lines 108a, 108b, and 108c, respectively. The carriers 104a-104c then respond by providing offers back to the head of operations 106 as shown by lines 110a, 110b, and 110c. The head of operations 106 then has the responsibility of forwarding the offers received by the carriers 104a-104c to the affiliates 102a, 102b, and 102c.

After a manual review of the offers, and potentially substantial communication regarding information omitted or misunderstood, the affiliates 102a-102c select at least one (and potentially 3-5) candidates for each tender line item.

Once a final award is designated, the winning carrier 104 divides the award document into multiple documents based on geography to determine any applicable regulatory requirements. The process of dividing the award document requires the carrier to rekey the award document into a desired format.

Finally, the shipper creates a new document containing only awarded business. This document is distributed to the shipper affiliates 102a, 102b, and 102c as well as to carriers 104a, 104b, and 104c and to designated third parties such as, e.g., freight forwarders, third party logistics, and accountants, for example.

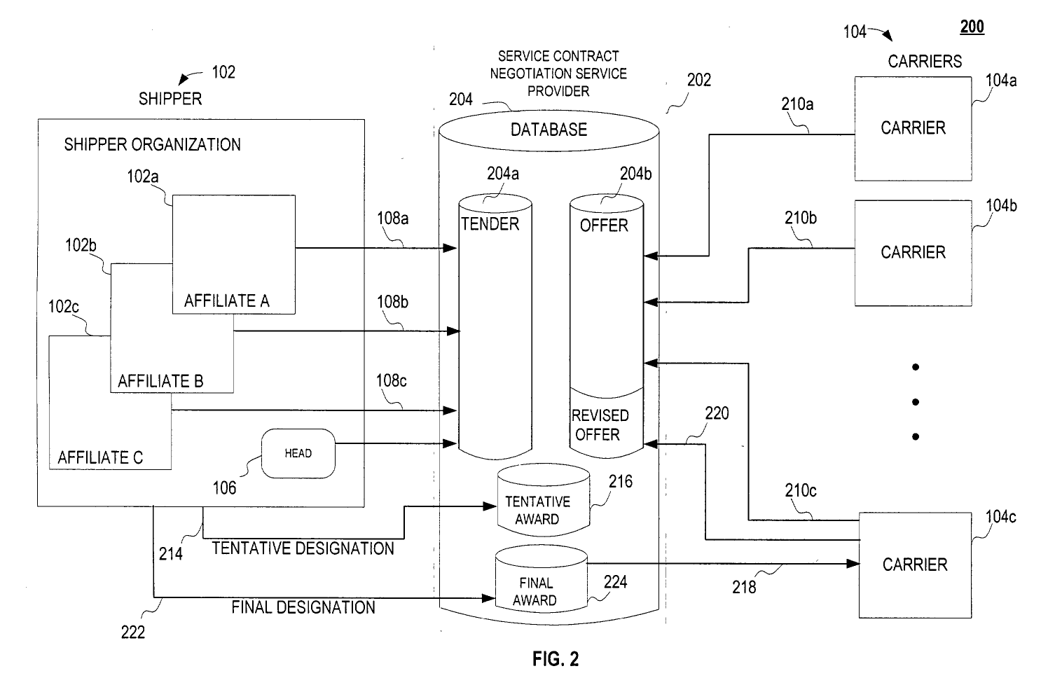

FIG. 2 is a diagram 200 illustrating an exemplary embodiment of a system, method, and computer program product for negotiating a service contract online via a service contract negotiation service provider 202 according to the present invention. According to an exemplary embodiment of the present invention the service contract negotiation service provider 202 comprises a database 204 which can include, e.g., a tender database 204a and an offer database 204b. Shipper affiliates 102a, 102b, and 102c, as well as head of operations 106, each can independently enter their tender line items online into tender database 204a as represented by arrows 108a-c. Carriers 104a, 104b, and 104c can be given online viewing access to the tender line items provided by the shipper 102. Carriers 104a, 104b, and 104c, as shown by arrows 210a-210c, can input offers online into offer database 204b. Shipper affiliates 102a, 102b, and 102c and head of operations 106 can be provided online viewing access of the offers submitted by the carriers 104. Each of the affiliates 102a-102c and the head of operations 106 can review the offers and designate 214, 222 at least one winning carrier 104 to whom to award a service contract. The winning carriers 104 can be notified by service contract negotiation service provider 202 as illustrated by line 218. As will be appreciated by one skilled in the art, in an exemplary embodiment, affiliates 102a, 102b, and 102c may provide a tentative designation 214 of one or more tentative award carriers 104. The results of tentative designation 214 can be stored in a tentative award database 216. The tentative winning carriers designated by the shipper 102 may be given an opportunity to submit a revised offer illustrated by arrow 220. The revised offer can be stored in a revised offer portion of the offer database 204b. Shipper affiliates 102a, 102b, and 102c can be provided online viewing access of the revised offers submitted by the tentative winning carriers. The shipper 102 can designate a final winning carrier as represented by final designation arrow 222. The final winning carrier can be designated online and the final designation 222 can be stored in award database 224. The final winning carrier 104c can be communicated as shown by arrow 218.

As will be appreciated by one skilled in the art, a shipper may need to amend a tender line item after the tender line item has been input into tender database 204a. Such an amendment may become necessary after a final winning carrier 104c has been designated by the shipper 102. If an amendment is necessary, the shipper 102, according to an exemplary embodiment of the present invention, may be given the opportunity to re-iterate the process described above in order to receive new offers based on the tender line items revised according to the necessary amendment. The shipper 102 may re-open the negotiation process to all carriers 104, or the shipper 102 may limit the negotiation to a subset of carriers 104 such as, e.g., to the tentative award carriers previously designated in step 214 by the shipper 102 prior to the amendment.

As will be apparent to those skilled in the art, an online service contract negotiation can be performed in various other ways within the spirit and scope of the present invention. For example, the need for tentative awardees and final awardees can be replaced by a single best and final offer and a single award designation.

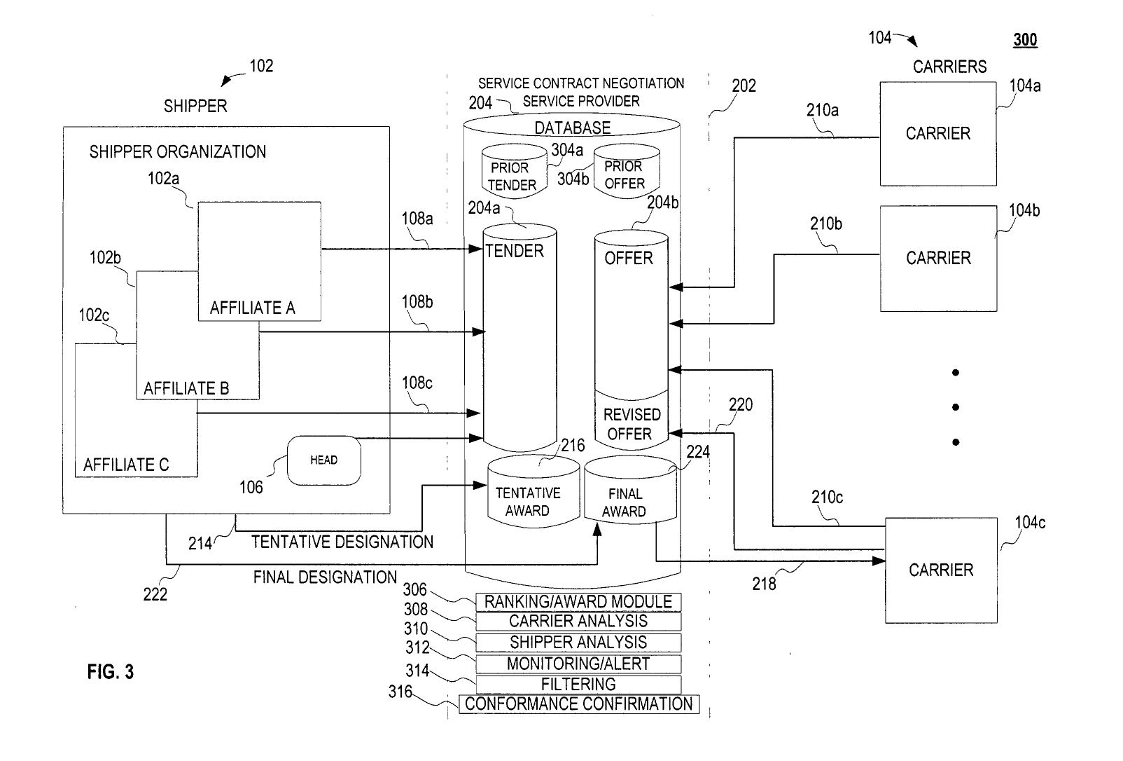

FIG. 3 depicts a diagram 300 illustrating a second exemplary embodiment of an exemplary service contract negotiation service provider interacting with one or more shippers 102 and carriers 104 according to the present invention. FIG. 3 illustrates exemplary features that can be performed according to an exemplary embodiment of the present invention in addition to those described above with reference to FIG. 2.

According to the present invention, a shipper 102 can input 108a-108c tender line items into tender database 204a. If a shipper has previously input tender line items into tender database 204a from an earlier year, for example, it may be advantageous for the shipper 102 to be able to use the tender line items previously input as a template for inputting another tender line item. According to the present invention, access to prior tender line items may be provided to the shipper through prior tender database 304a. In an exemplary embodiment prior tender data can, by default, populate fields of the records of tender database 204a. Likewise, a carrier 104 may find it advantageous to use a prior offer as a template for making another offer. Access to prior offers may be provided to the carrier 104 through prior offer database 304b.

In one exemplary embodiment, a ranking/award module 306 may be provided to assist a shipper 102 in the awarding process by ranking offers according to price, route, or time frame, for example. It is to be understood by one skilled in the art that ranking/award module 306 can also allow a shipper to specify another factor by which offers can be ranked.

In an exemplary embodiment, historical information concerning a carrier 104 may be useful to a shipper 102 in the process of choosing a carrier 104 to designate a tentative winning carrier 104 or a final winning carrier 104c. Information concerning a carrier 104 may include, for example, how frequently a carrier 104 keeps the actual billing within a given percentage of the price given by the carrier 104 as part of the offer. This type of information may be made available by a carrier analysis module 308 according to an exemplary embodiment of the present invention.

In another exemplary embodiment, historical information concerning a shipper 102 may be useful to a carrier 104 when preparing an offer. Such information may include, for example, a price previously offered to the shipper 102 or an indication of whether the carrier 104 was designated as the winning carrier 104. It may also be advantageous to a carrier 104 to have access to previous tender line item information such as the origin, destination, time frame, or container size requested by the shipper 102. This type of information may be made available by a shipper analysis module 310 according to an exemplary embodiment of the present invention.

A monitoring/alert module 312 may be provided according to another exemplary embodiment of the present invention. Monitoring/alert module 312 may be used to monitor whether a shipper 102 is staying within a service contract, i.e., using an awarded carrier 104c. Monitoring/alert module 312 may also track the number of units moved versus a minimum quantity commitment (MQC) agreed-upon in the service contract and can alert the shipper 102 and/or the carrier 104 of, e.g., progress toward a MQC, or reaching the MQC. This tracking feature may be used, for example, to determine a payment due from the shipper 102 to the carrier 104 if the number of units moved is less than the MQC levels committed to according to the service contract. This tracking feature may also be used, for example, notify the shipper 102 if the number of units moved by a carrier 104 is more than a number agreed-upon in the service contract.

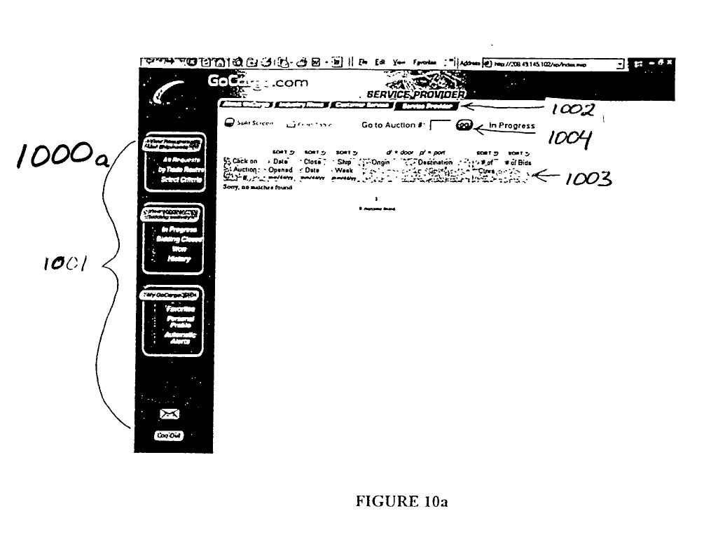

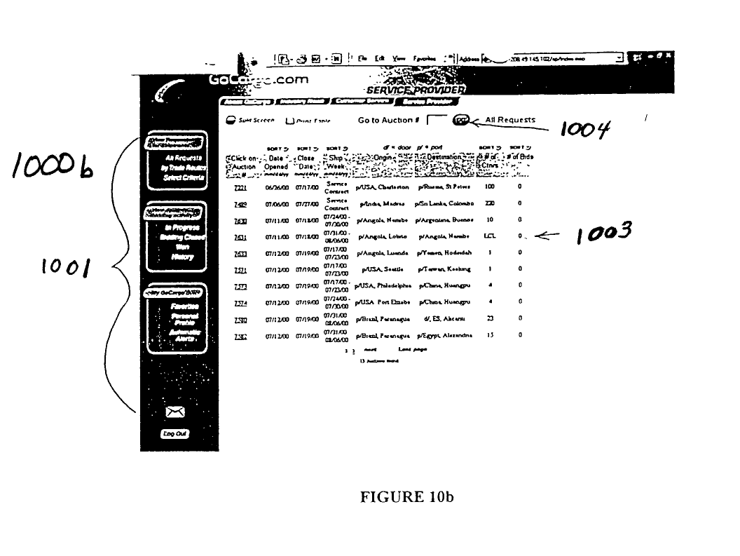

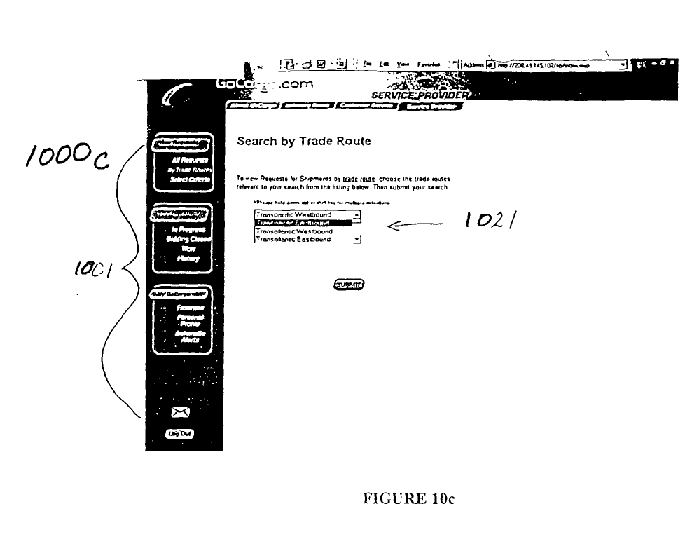

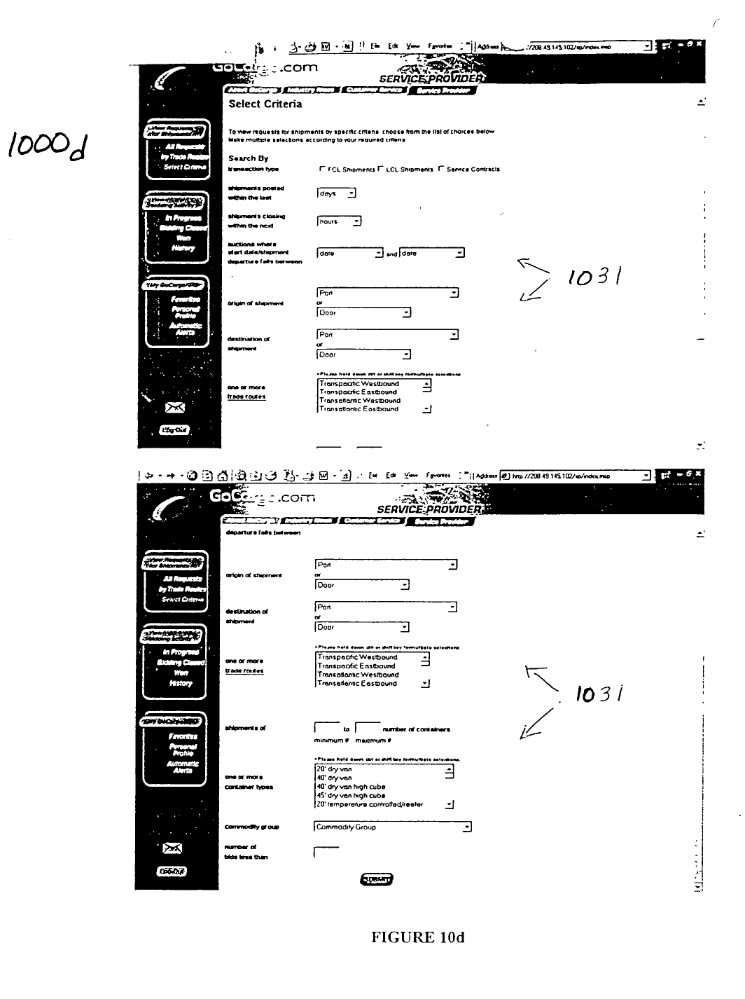

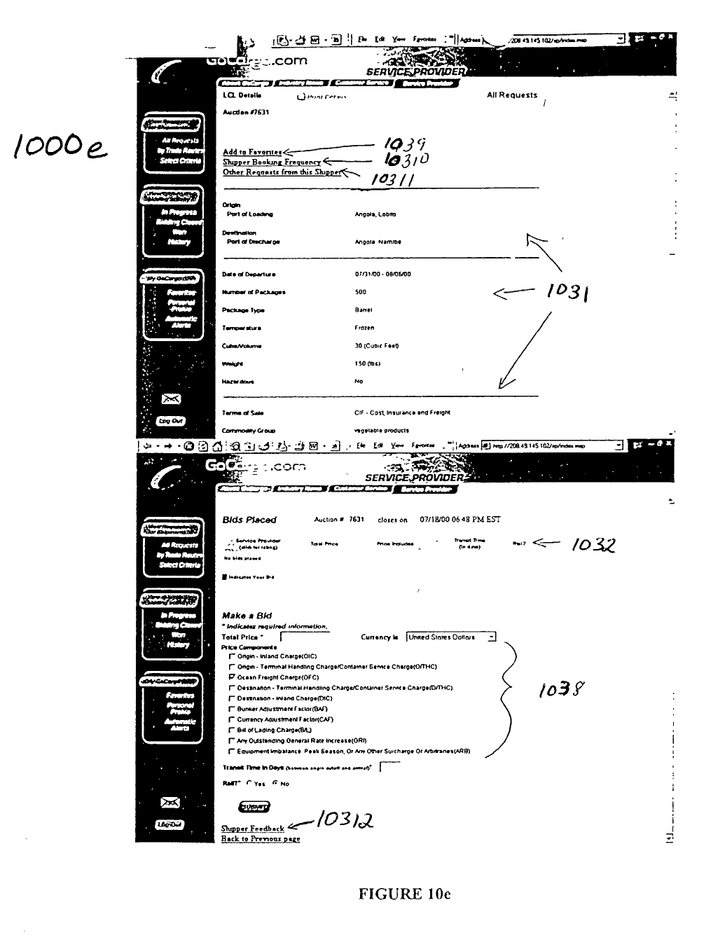

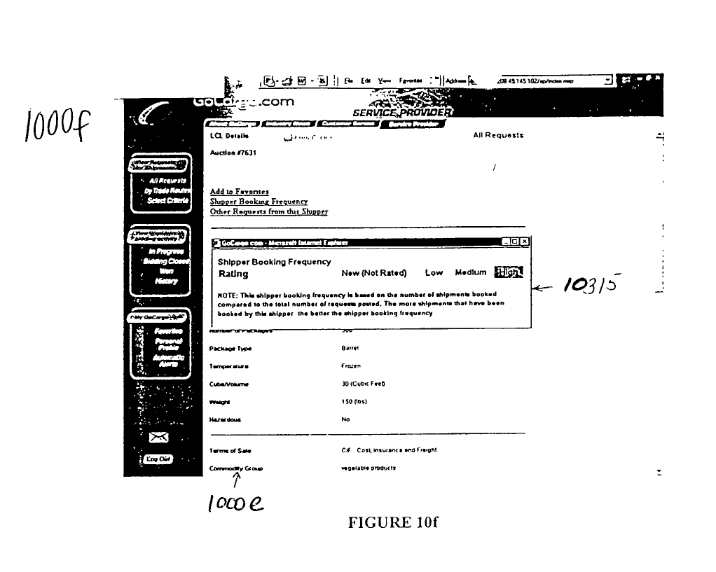

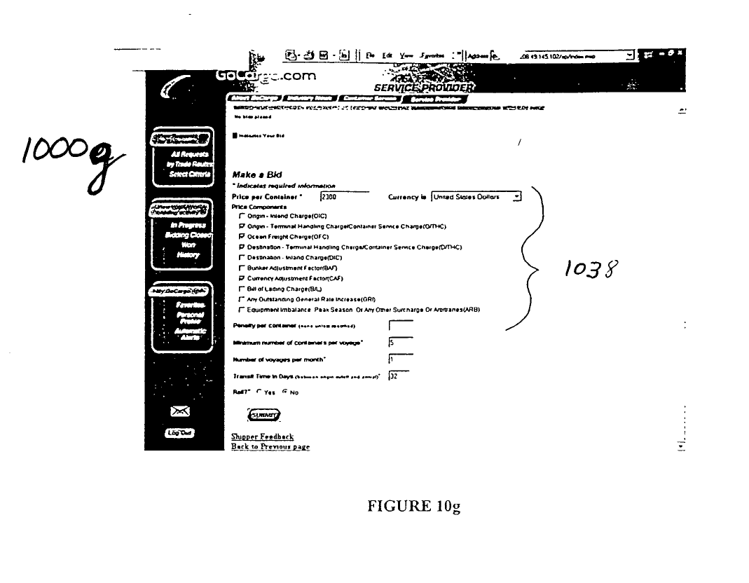

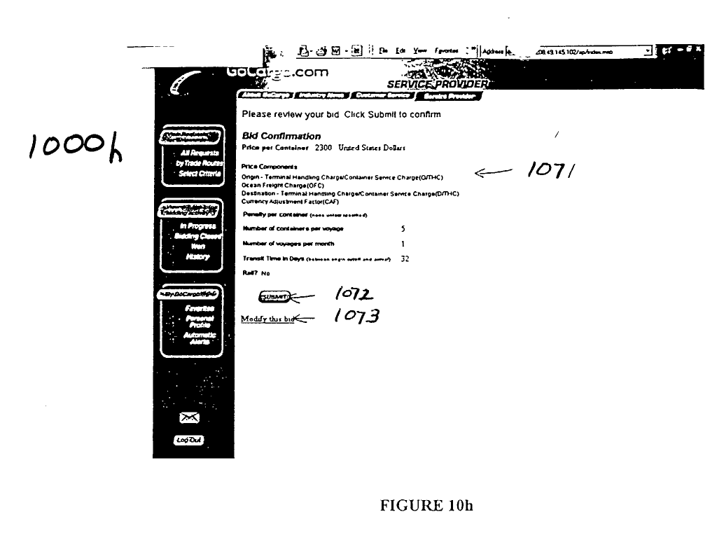

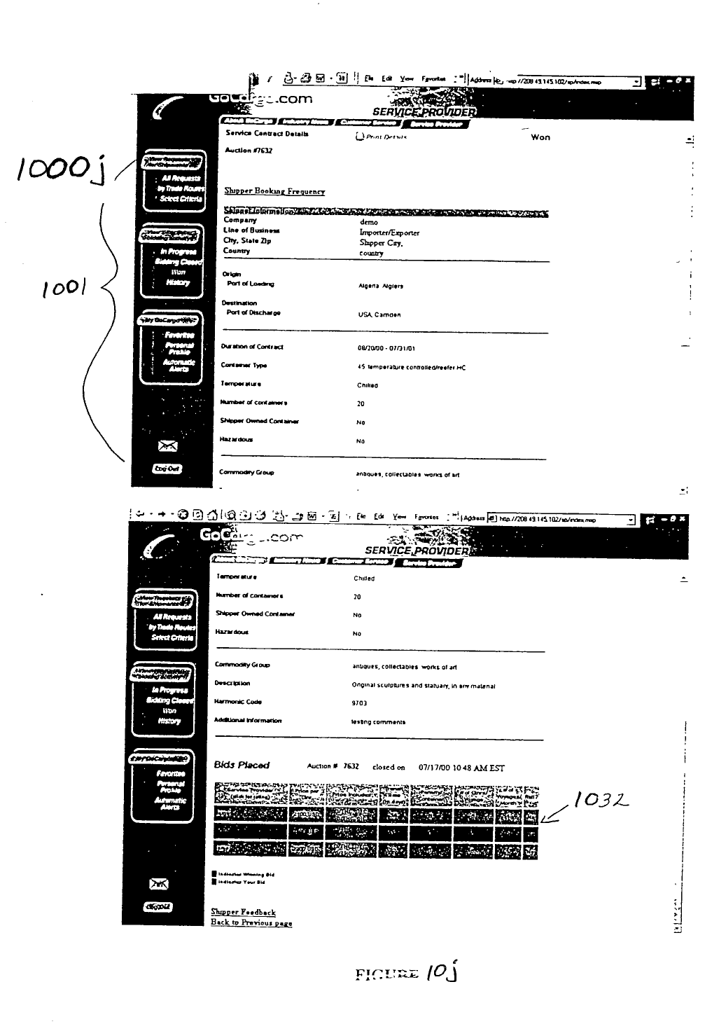

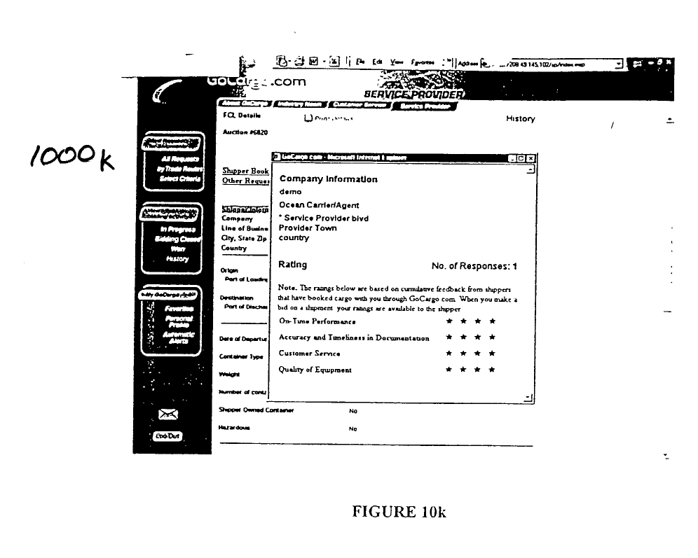

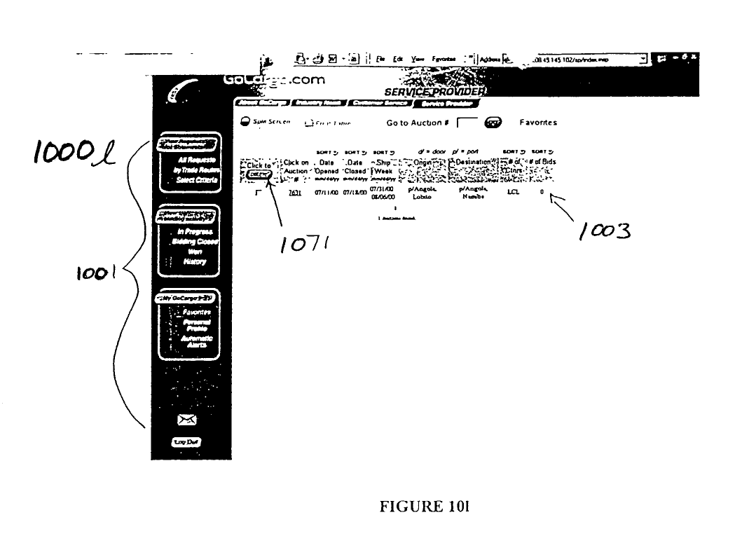

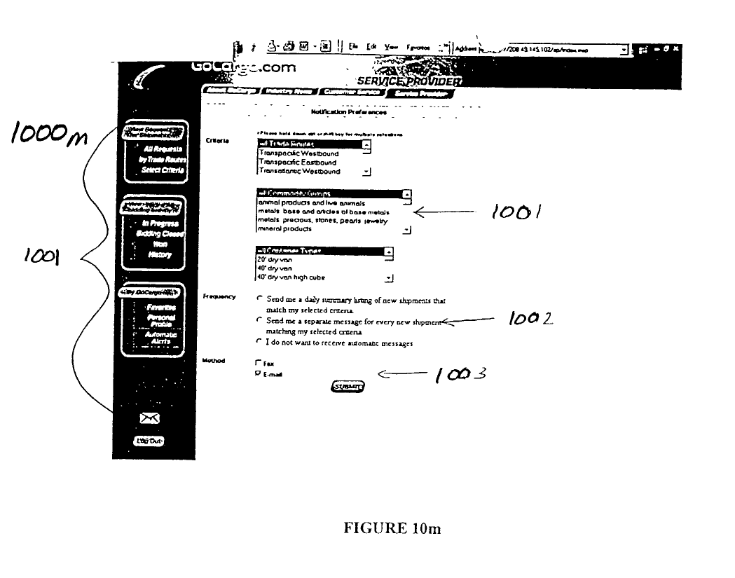

A filtering module 314 may be provided according to another exemplary embodiment of the present invention. Filtering module 314 may be used to allow shippers 102 and carriers 104 to query the tender and offer databases 204a and 204b, respectively, and to filter a desired report according to available filter agents. A shipper 102 may want to produce a report showing only those carriers 104 offering a certain route, time frame, or price, for example. A carrier 104 may be interested in finding a shipper 102 who has submitted a tender line item comprising a certain origin, destination, or a container of a given size, for example. Further details as to how such a report may be made available are described below with reference to FIG. 10.

A conformance confirmation module 316 can be provided according to yet another exemplary embodiment of the present invention to confirm if and when a carrier 104 has completed all necessary regulatory actions required by regulatory bodies such as the Federal Maritime Commission, for example. Required regulatory actions may include, for example, tariffs which may need to be filed with the federal government before a service contract is considered legal.

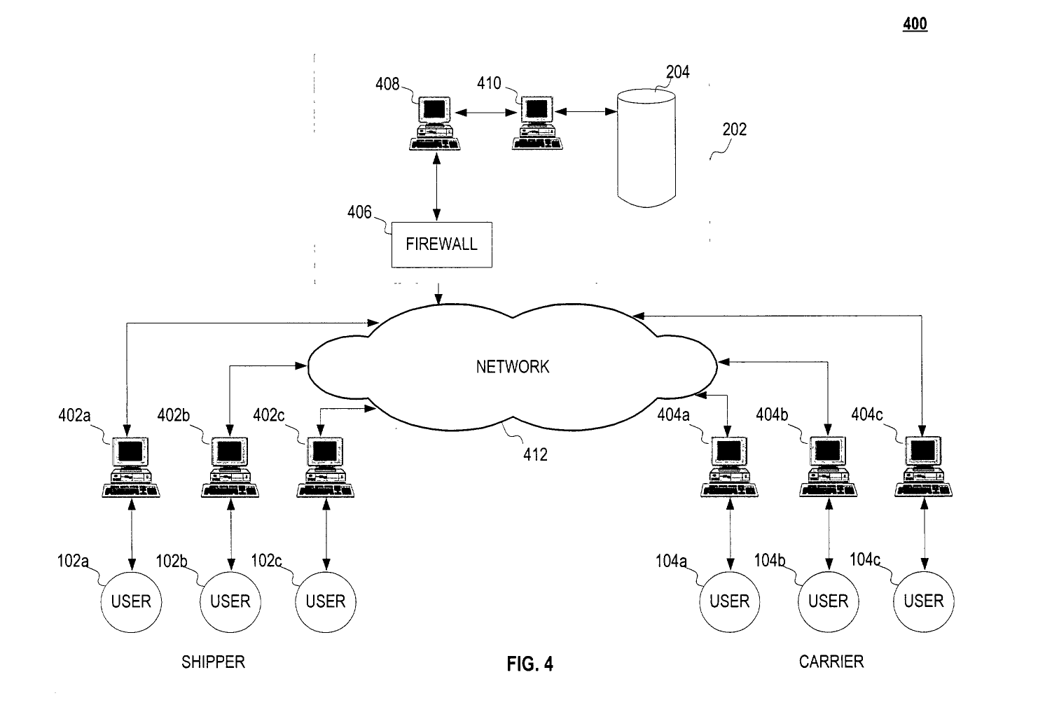

FIG. 4 is a diagram 400 illustrating an exemplary computing and communications architecture environment in which a method according to the present invention may be applied. Shipper users 102a, 102b, and 102c can have access to terminals 402a, 402b, and 402c, respectively. Terminals 402a, 402b, and 402c can in turn provide access by shippers 102a-102c to a service contract negotiation service provider 202 through a network 412 such as, e.g., the Internet. The service contract negotiation service provider 202 can provide online access to database 204. Specifically, shipper affiliates 102a, 102b, and 102c can access database 204 via the network 412 through, e.g., a firewall 406, a web server 408, and an application server 410 coupled to database 204. Carriers 104a, 104b, and 104c can have similar access to database 204 via terminals 404a, 404b, and 404c, respectively.

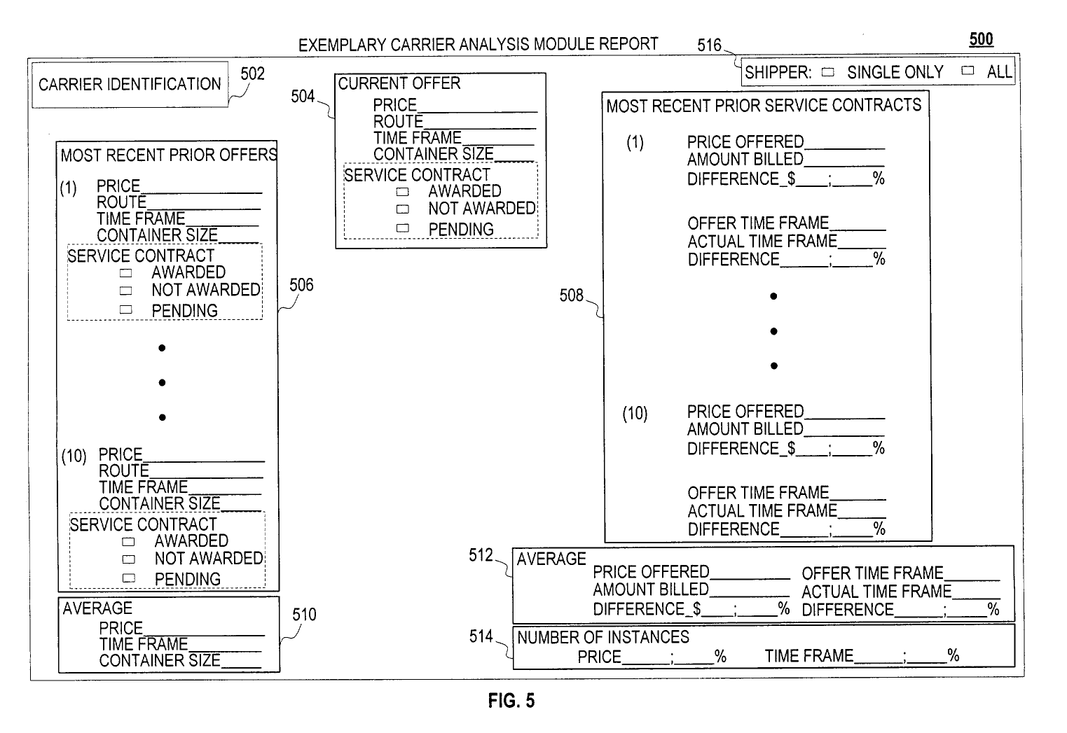

FIG. 5 illustrates an exemplary report 500 which may be provided by the carrier analysis module 308 according to an exemplary embodiment of the present invention. For example, the report can be outputted as printable output or may be displayed, e.g., as part of a graphical user interface application on a shipper's terminal 402a-402c. The report 500 may be accessible by a shipper 102 interested in viewing helpful historical or statistical information concerning a carrier 104. The report 500 may include, e.g., carrier identification 502 such as a name or an identification number, for example. The report 500 may further include, e.g., a summary 504, providing a summary of a current offer a carrier 104 may have recently submitted, including information from the corresponding tender line item such as the price, route, time frame, and container size, for example. The summary of a current offer may also include an indication of the status of the offer, such as, e.g., “Awarded,” “Not Awarded,” or “Pending.” The report 500 also may include a recent prior offer list 506, showing a summary of recent prior offers from prior offer database 304b, providing the same information for prior offers as for the current offer as described above, for example. The shipper 102 may be able to view information from all prior offers or limit the number of prior offers shown in the report to a maximum number such as 10, for example. As will be apparent to those skilled in the art, other formats containing other or additional information and/or formatting can be provided according to the present invention.

The report 500 also may include, e.g., a summary 508, summarizing recent prior service contracts awarded by the shipper 102 to the carrier 104. The summary may include information such as a price given in the offer, the actual billing, and any calculated difference between the two, for example. The difference in price may be presented as a dollar or other currency amount. In one embodiment, an offer time, actual time and difference can also be provided including the appropriate unit measure of time (e.g., day, week, month). The differences may be presented as percentage differences, for example. Again, the shipper may choose to view all past service contracts or limit the number of service contracts summarized to a maximum number such as 10, for example.

The report 500 also may include, e.g., a calculated offer average 510, providing an average price, time frame, and container size for recent prior offers 506. The report 500 also may include a calculated service contract average 512, providing an average for the information shown in relation to recent prior service contracts 508. The report 500 also may include a number of instances of variance indicator 514, indicating the number of instances where, e.g., the amount billed by the carrier 104 has differed from the price included in the offer submitted by the carrier 104. The number of instances may be presented as a number, or as a percentage of the total number of past service contracts awarded to the carrier 104.

It is to be understood by one skilled in the art that there are several options for presenting the information included in the report 500. The information could be displayed, for example, online as a single page, as multiple pages, through hyperlinks, as a printed report, as an applet, as an application or graphical user interface (GUI), or distributed through email, wireless transmission page, or by fax or mail, for example.

The shipper 102 also may have the ability, as illustrated in feature 516, to select whether the report 500 shows information corresponding to only that particular shipper affiliate 102a, 102b or 102c, or a compilation of information from all affiliate shippers 102a-102c.

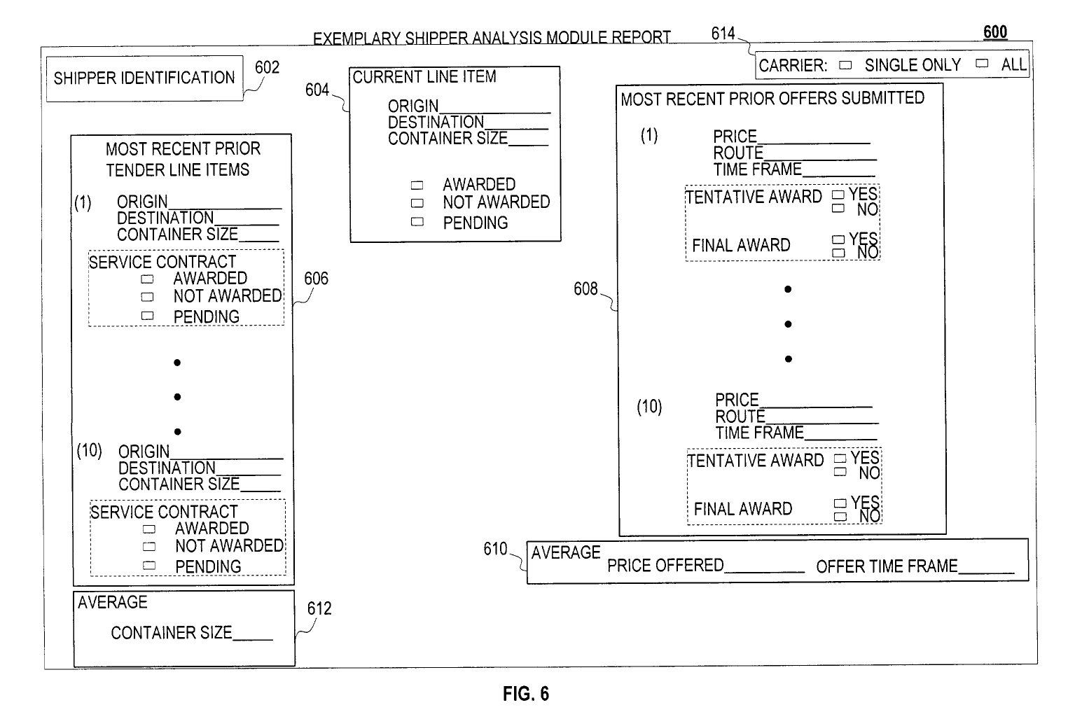

FIG. 6 illustrates an exemplary report 600 which may be provided by the shipper analysis module 310 according to an exemplary embodiment of the present invention. As with report 500, report 600 can be, e.g., an on line accessible graphical user interface (GUI) and need not be a printed hard copy. The report 600 may be accessible by a carrier 104 interested in viewing helpful historical or statistical information concerning a shipper 102. The report 600 may include shipper identification 602 such as a name or an identification number, for example. The report 600 may include a summary 604, providing a summary of a current tender line item a shipper 102 may have recently submitted, including information from the tender line item such as the origin, destination, and container size, for example. The summary of a current tender line item may also include an indication of the status of an offer the carrier 104 may have submitted in response to the tender line item, such as “Awarded”, “Not Awarded”, or “Pending”. The report also may include a most recent prior tender line items list 606, showing a list of recent past tender line items submitted by the shipper 102, providing the same information for prior tender line items as for the current tender line item as described above, for example. The carrier 104 may, in an exemplary embodiment, be able to view information from all prior tender line items or limit the number of prior tender line items shown in the report to a maximum number such as 10, for example.

The report 600 may also include, e.g., a summary 608, summarizing any recent past offers submitted by the carrier 104 in response to tender line items submitted by the shipper 102. The summary may include information given in the past offer such as a price, a route, and a time frame, for example. The summary also may include an award status for each prior tender line item indicating whether the carrier 104 received a tentative awarded, a final award, both tentative and final awards, or neither tentative nor final awards, for example. Again, the shipper 102 may choose to view all past service contracts or limit the number of service contracts summarized to a maximum number such as 10, for example.

The report 600 also may include a calculated average 610, providing, e.g., an average price or time frame included with all summarized offers submitted to the shipper 102. The report 600 may also include, e.g., a calculated average 612, providing the average container size included in all summarized tender line items submitted by the shipper 102.

It is to be understood by one skilled in the art that there are several options for presenting the information included in the report 600. The information could be displayed, for example online as a single page, as multiple pages, through hyperlinks number, through email, by wireless transmission, page, or by fax or mail, for example.

The carrier 104 in one embodiment, may also have the ability to select whether the report shows information corresponding to only that particular carrier 104, or a compilation of information from all carriers 104 who have submitted at least one offer for the shipper 102 or from all carriers 104 within a selected geographic region or industry grouping. This ability is shown as option 614.

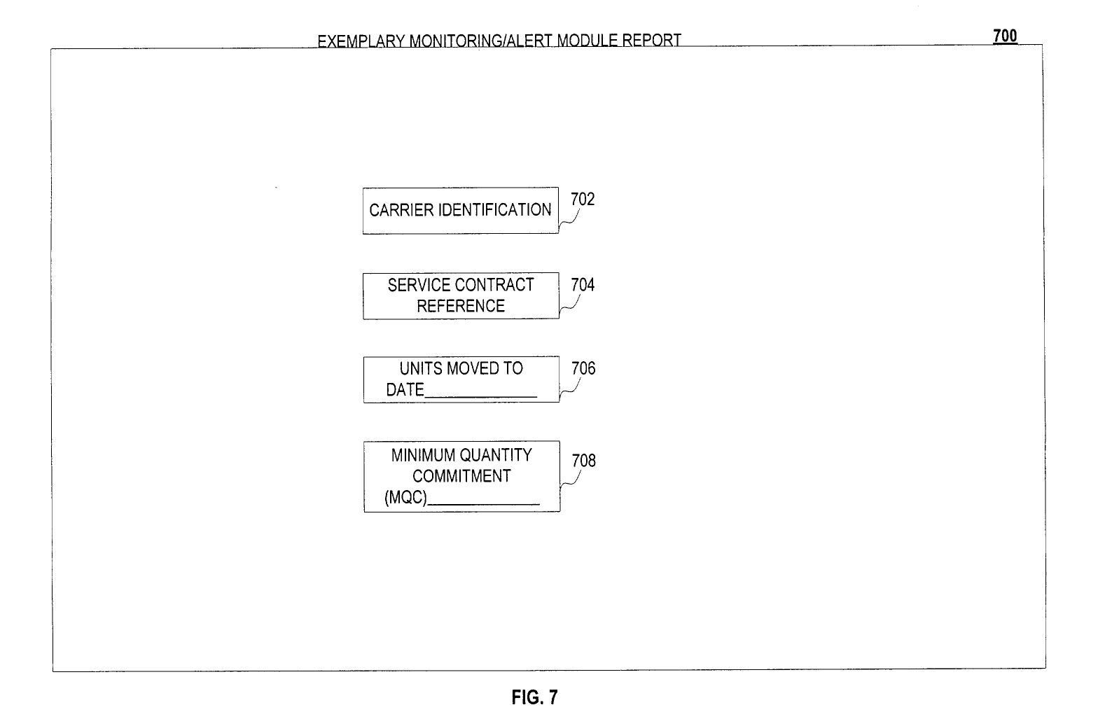

FIG. 7 illustrates an exemplary report 700 which can be provided by the monitoring/alert module 312 according to an exemplary embodiment of the present invention. The report can be of a format similar to reports 500, 600. The report 700 may be accessible by a shipper 102 who is interested in viewing a status report for an awarded service contract. The report 700 may include, in an exemplary embodiment, carrier identification 702 such as a name or an identification number, for example. The report 700 may include a service contract reference 704 for outputting a service contract reference, such as a contract identification number, for example. The report 700 also may include a volume indicator 706, indicating the number of units moved by the carrier 104 that has exceeded a threshold as of the current date. The report 700 also may include, e.g., an indication 708 indicating a minimum quantity commitment (MQC) agreed upon in the service contract that, e.g., could have been exceeded prompting an alert notification.

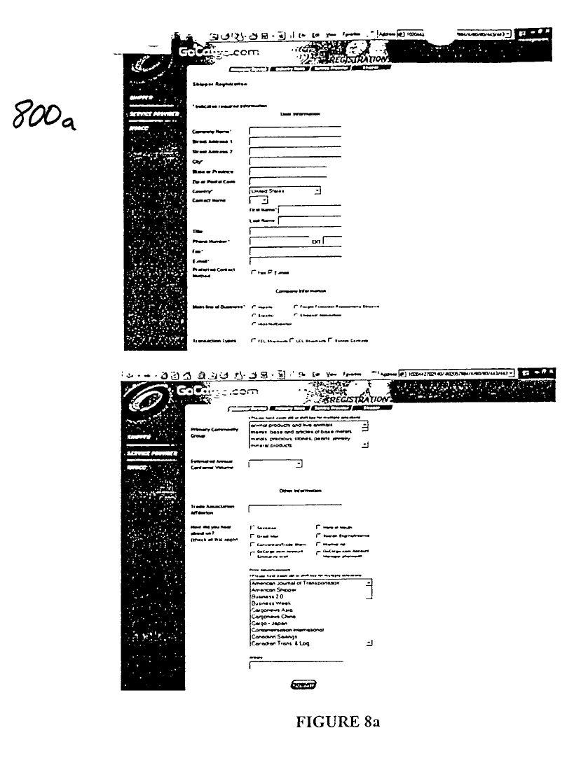

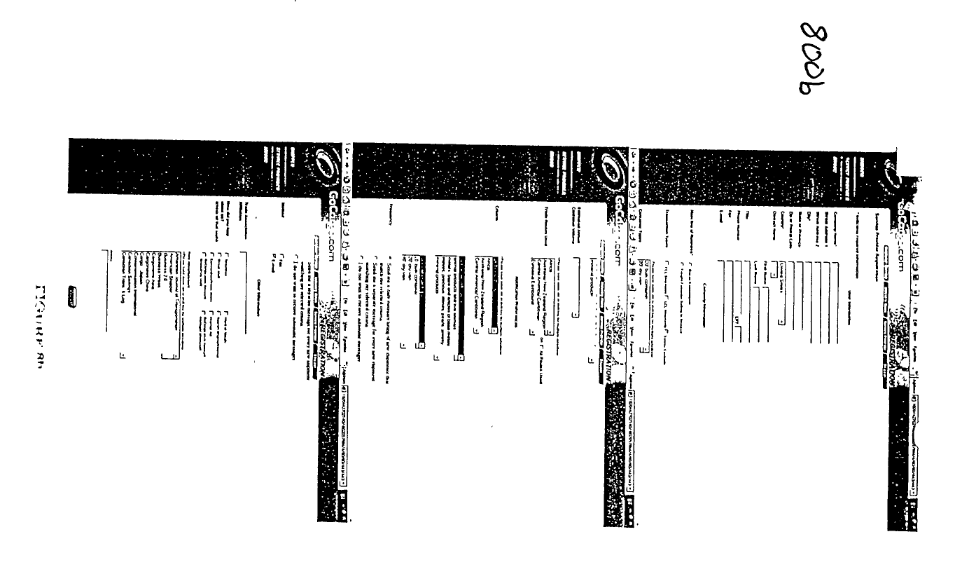

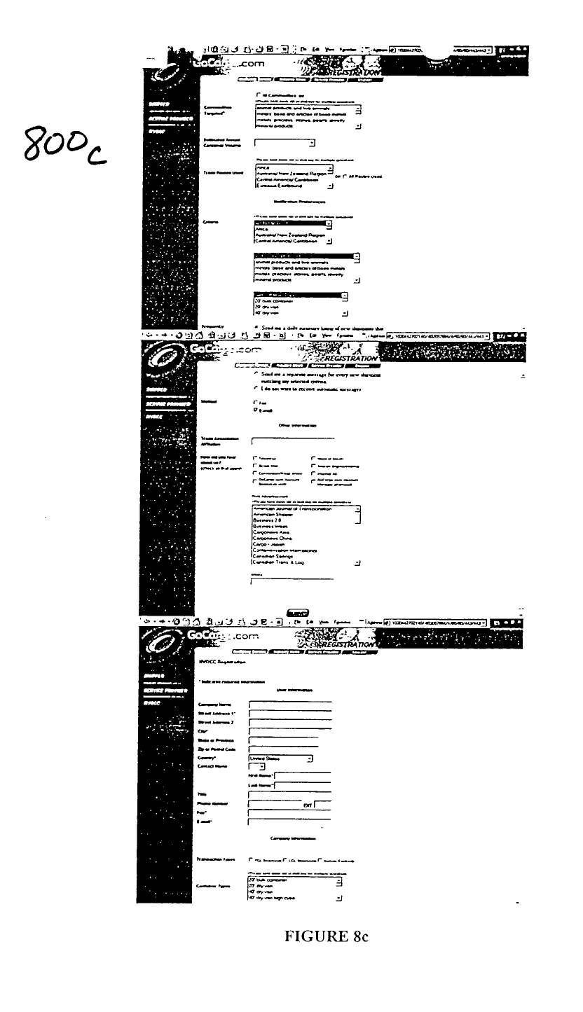

FIGS. 8a-8c illustrate exemplary graphical user interface (GUI) Registration screens for Shippers 800a, Carriers 800b, and NVOCCs 800c, respectively. Non-registered users can access the appropriate Registration screens 800a-800c to register and become registered users.

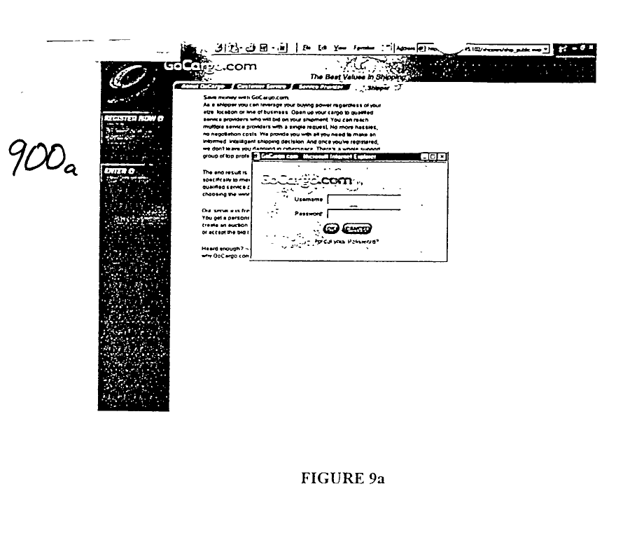

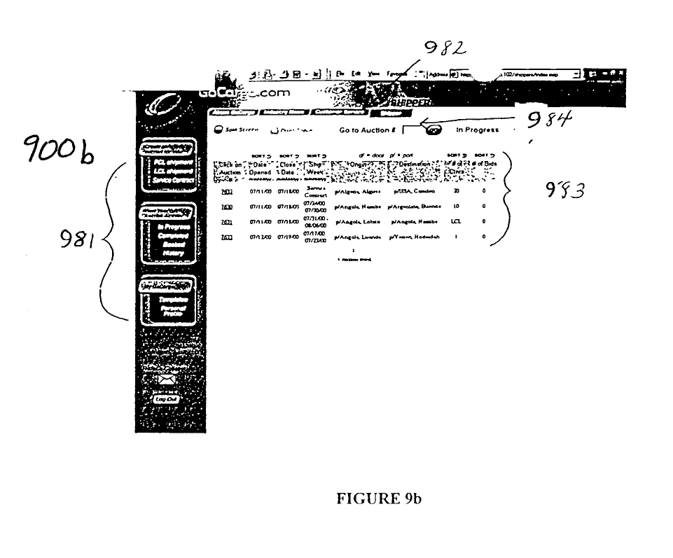

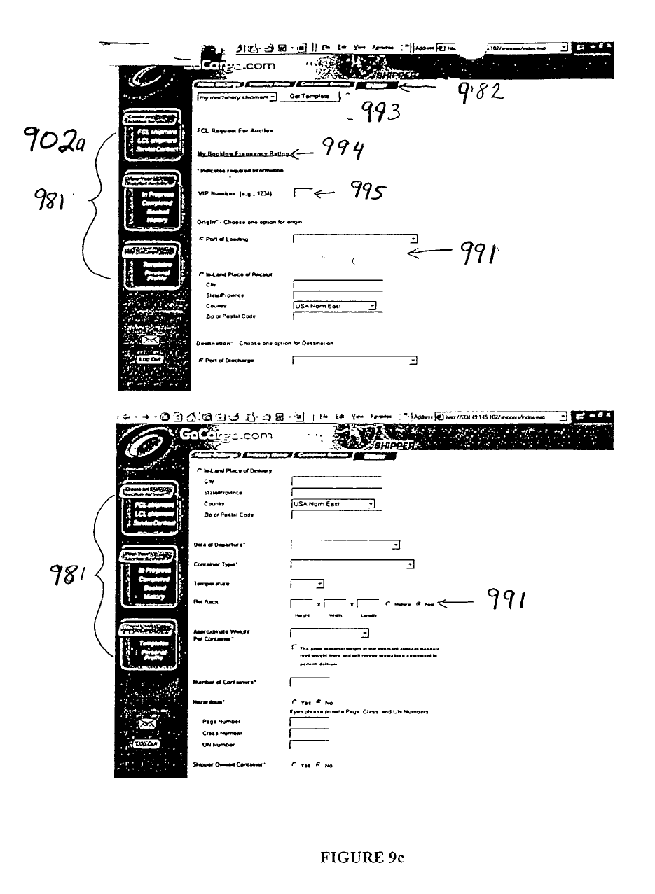

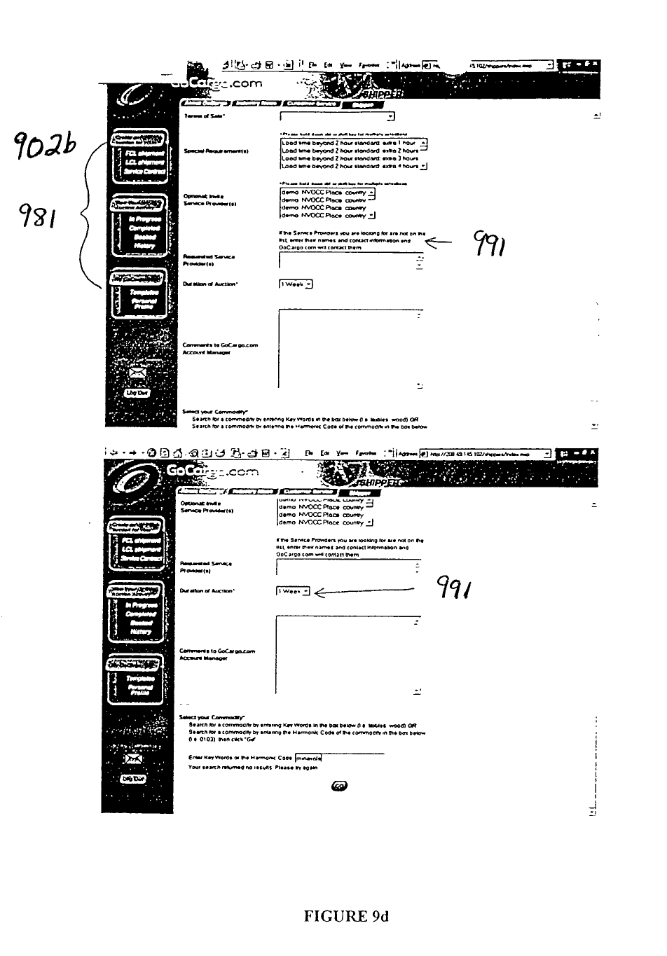

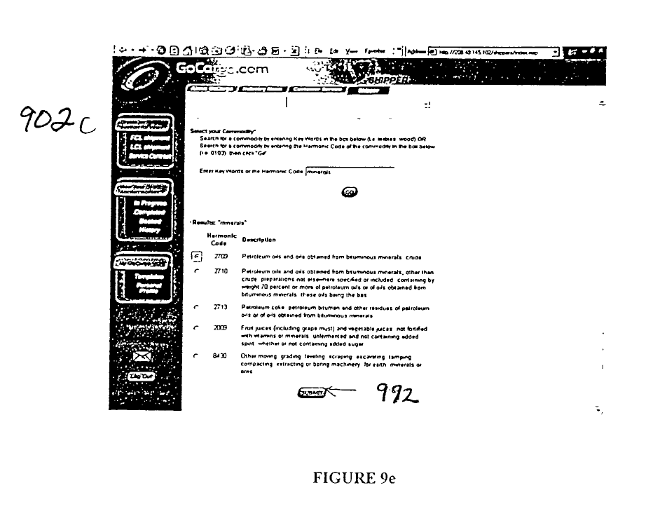

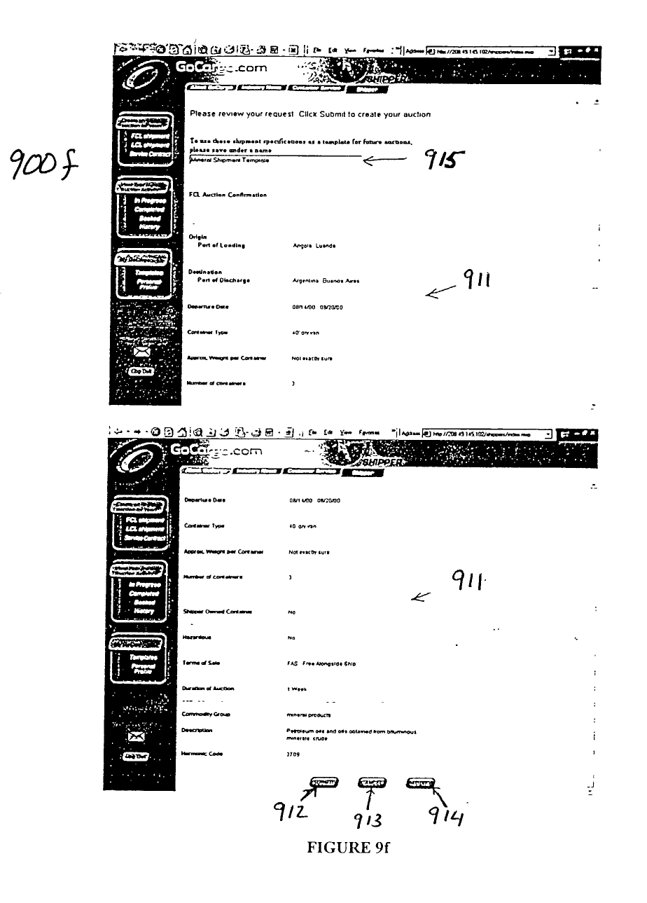

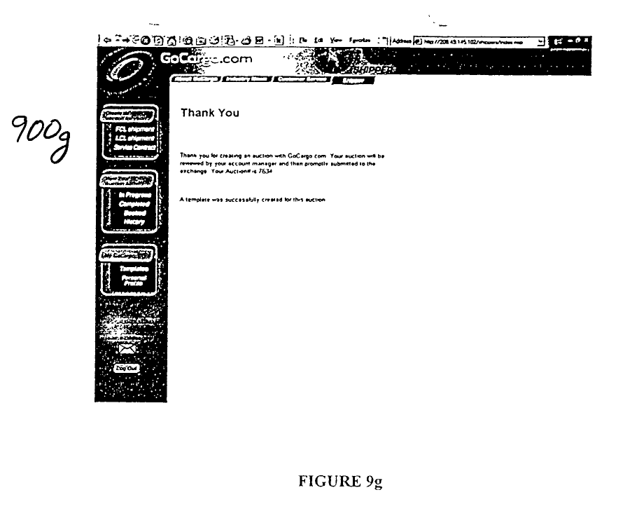

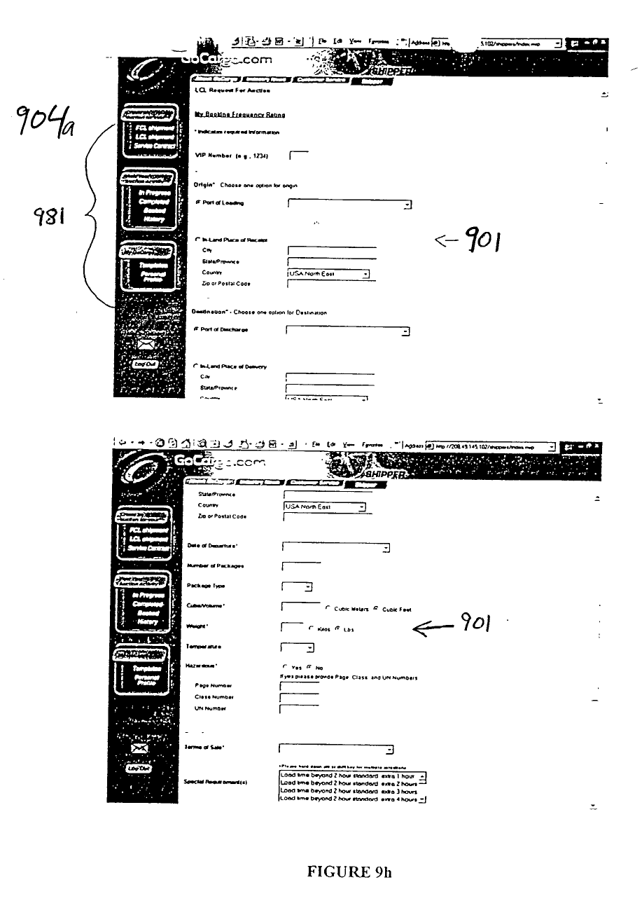

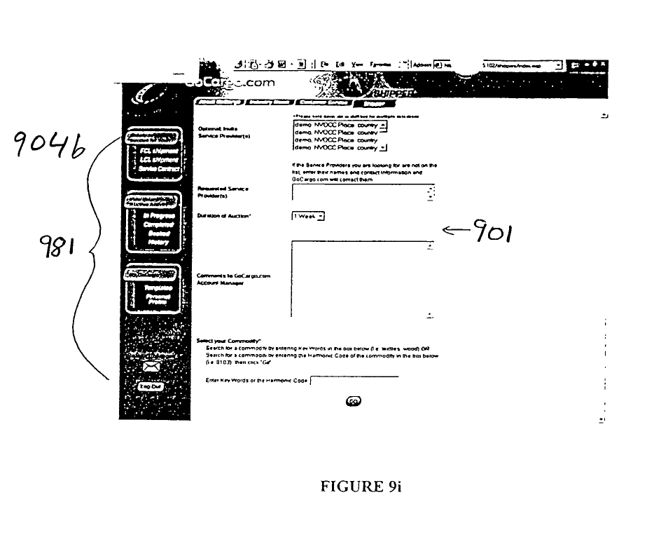

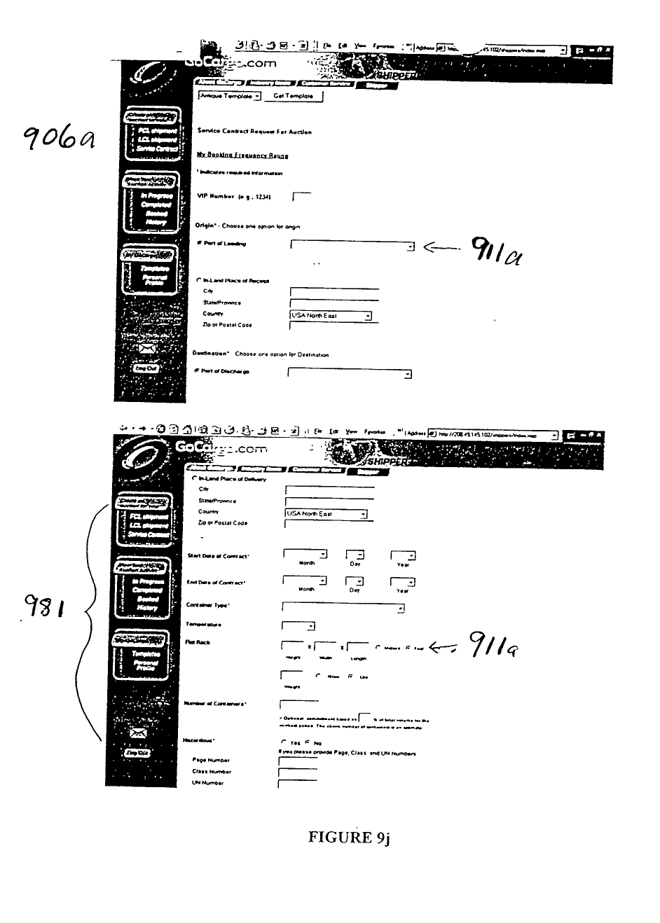

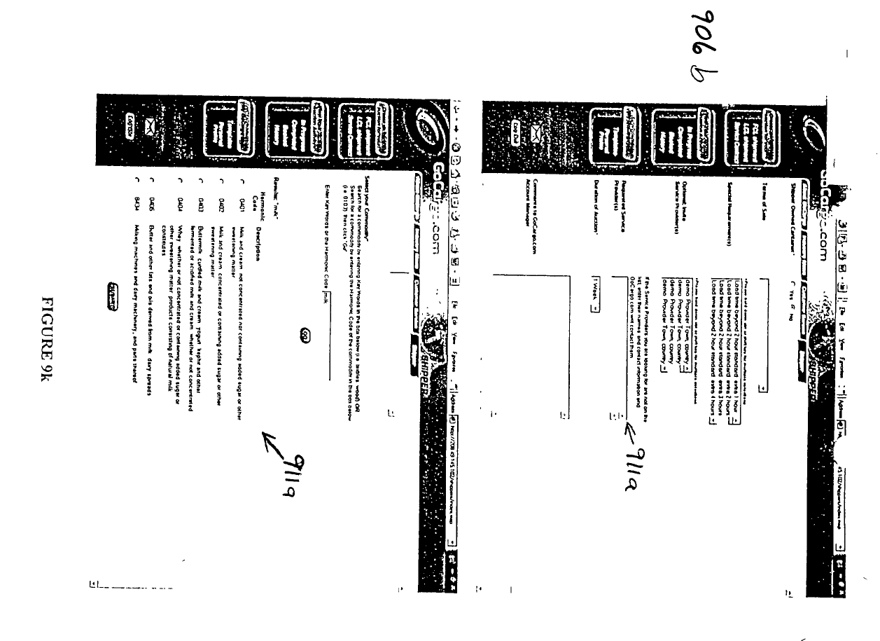

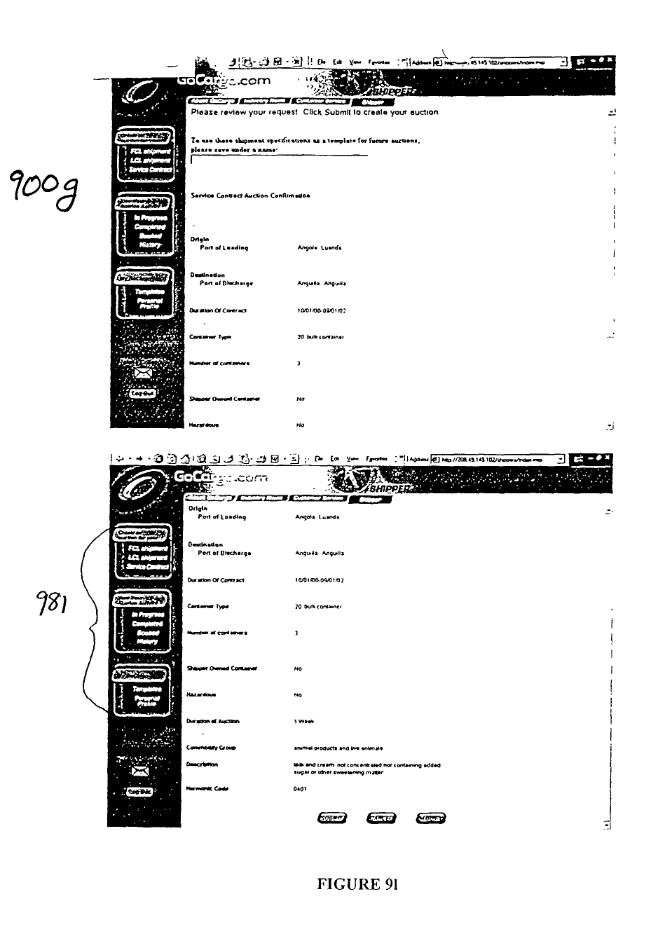

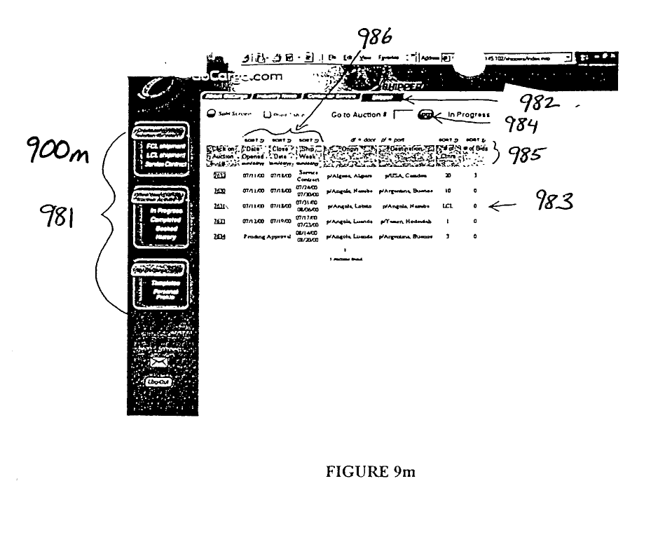

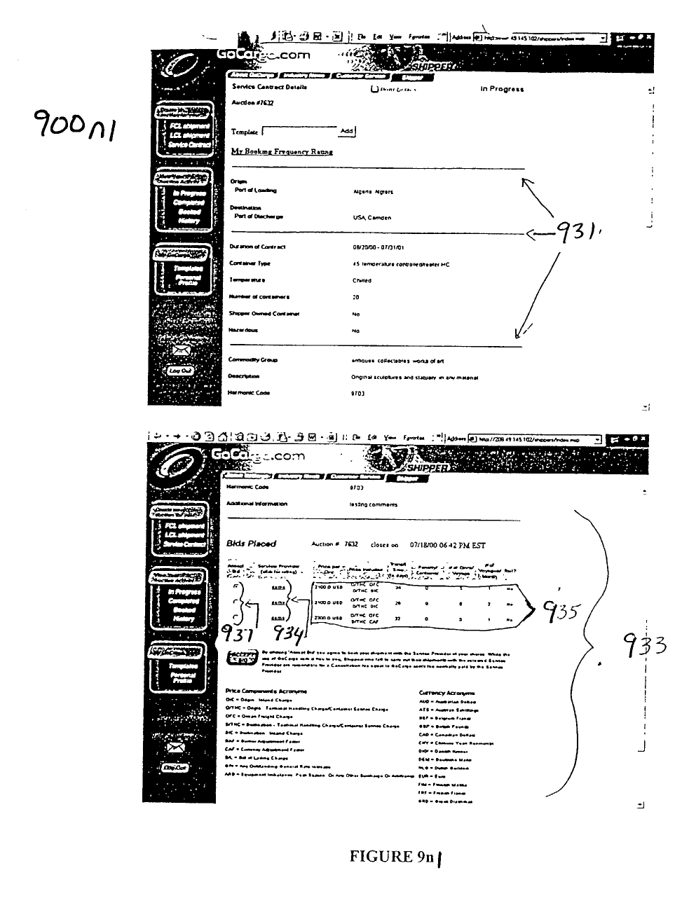

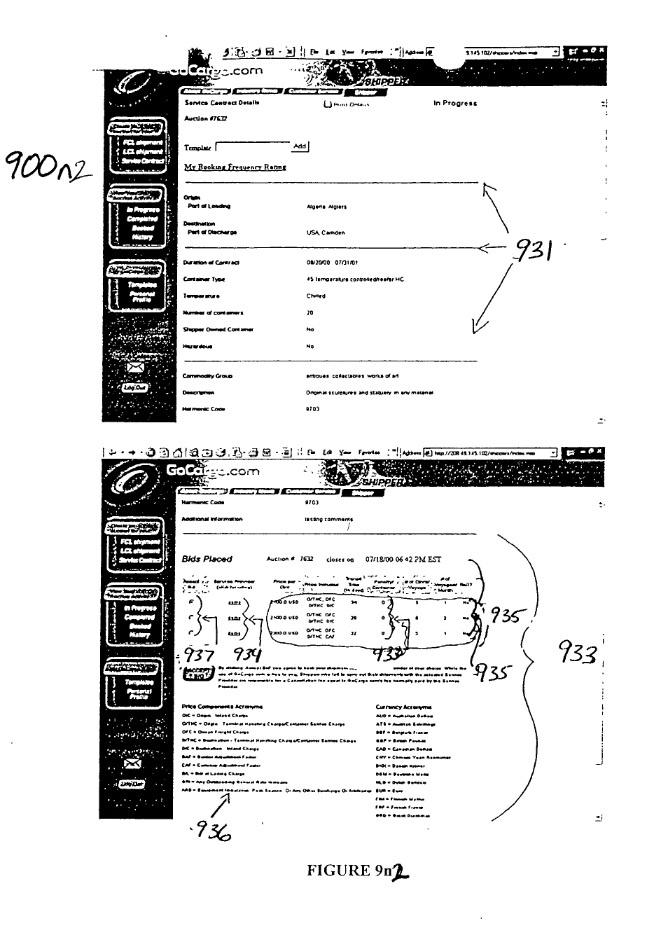

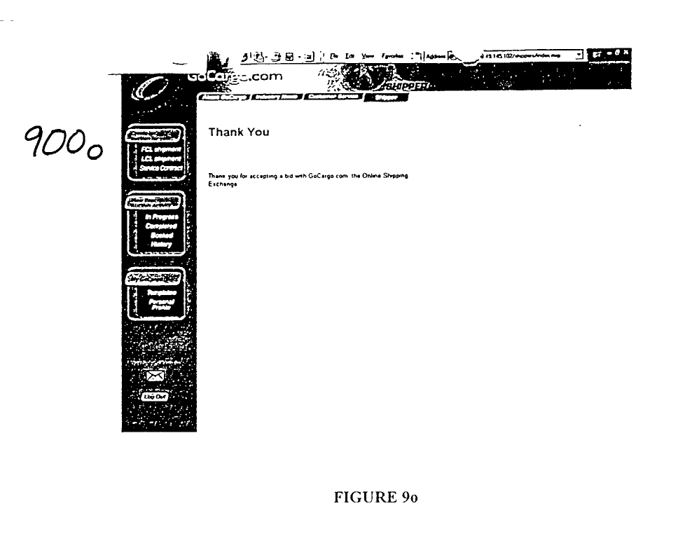

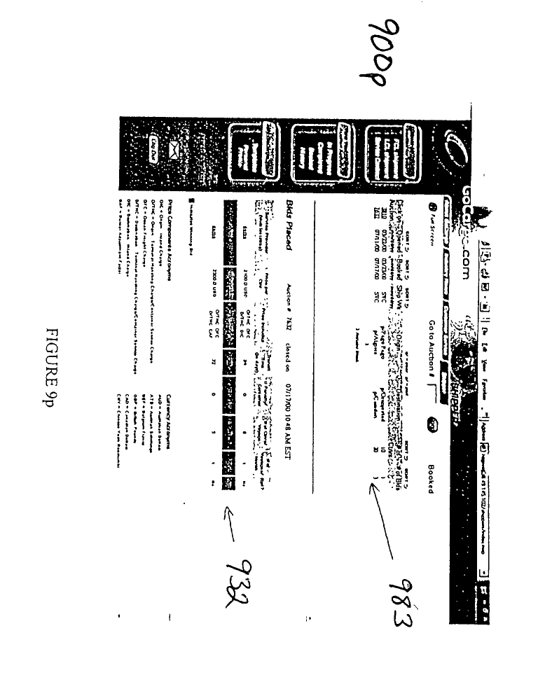

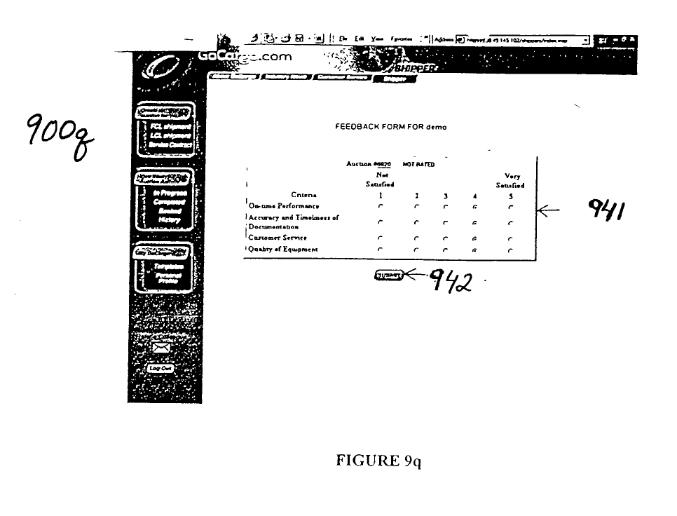

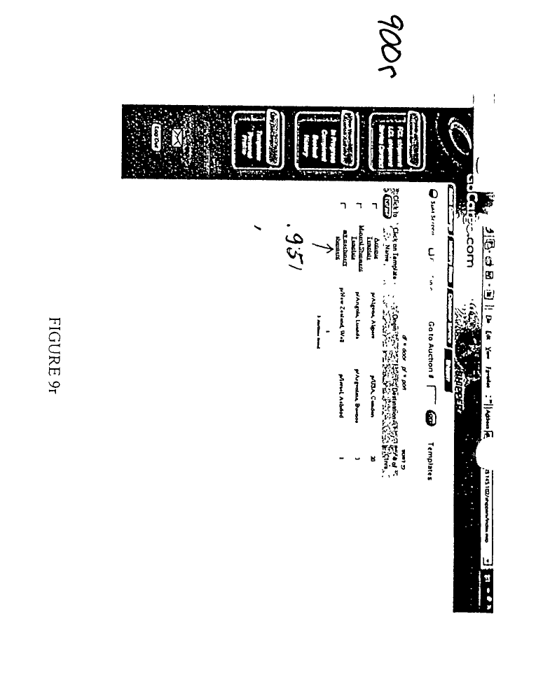

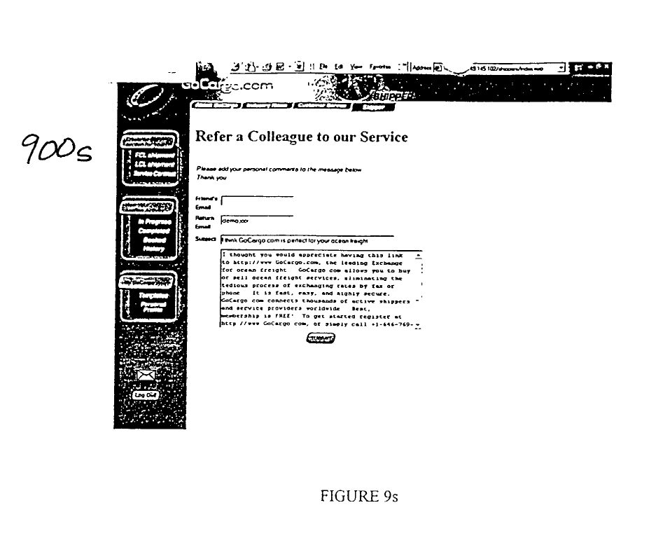

FIGS. 9a-9s illustrate exemplary GUI screens that may be accessed by a Shipper in an exemplary embodiment of the present invention.

FIG. 9a illustrates the Login screen 900a. Registered users can access the Login screen 900a to logon. After registering, the registered user may receive an email with a link to the Login screen 900a; at the Login screen 900a, the registered user may enter a user id and password to logon. The Login screen 900a can include username and password data fields in which a registered user, in this example a Shipper 102, can enter its username and password and Ok and Cancel buttons. Selecting the Ok button can cause the entered username and password to be transmitted to the server of the service contract negotiation service provider 202. The server may check an appropriate database for a matching username and password. If the username and password are valid and a match is found with a registered Shipper 102, the server can direct the web browser to display the Shipper screen 900b of FIG. 9b.

FIG. 9b illustrates an exemplary embodiment of the Shipper screen 900b. The Shipper screen 900b comprises Shipper links 981, tabbed links 982, an activity table 983 and a Go To Tender section 984. The Shipper links 981 can include hyperlinks to various screens that the Shipper can access. By selecting these hyperlinks, the Shipper can access these screens. The activity table 981 can include a list of hypertext tender numbers for the Shipper's live tenders (tenders available for bidding) and pending tenders (tenders awaiting Account Manager approval), if any. Selecting one of the hypertext tender numbers from the activity table 983 triggers the display of the tender detail screen 900n for the selected tender. It is noted that other screens accessible from the Shipper screen 900b may also include the Shipper links 981, the tabbed links 982 and/or the activity table 983.

FIGS. 9c-9e illustrate exemplary embodiments of the Create full-container-load (FCL) Shipment screen 902a, b and c that can be used to initiate a one-time FCL shipment tender and which can be accessed through the corresponding hyperlink in the Shipper links 981 of the Shipper screen 900b. Note that each FIGS. 9c-9e illustrate different portions of the Create FCL Shipment screen 902a-902c (referred to hereafter collectively as 902). The Create FCL Shipment screen 902 can include shipping requirements sections 991 (data fields, pull-down, scrolling or pop-up menus, etc.) for entering shipping requirements data for an FCL Shipment. Accordingly, there are sections for such shipping requirements data as port of loading, in-land place of receipt (e.g., city, state/province, country, zip or postal code), port of discharge, in-land place of delivery (e.g., city, state/province, country, zip or postal code), date of departure, container type, temperature, flat rack dimensions, approximate weight per container and indication of weight exceeding standard road weight limits, number of containers, hazardous material indication and page, class and UN numbers if hazardous, shipper-owned container indication, terms of sale, special requirements, service provider invitation(s) for registered Service Providers, service provider request(s) to contact unregistered Service Providers, duration of the tender, comments to Account Managers and optionally a commodity selection (indicated by Harmonic Code entered by Shipper or selected from list of Harmonic Codes and their descriptions generated from search conducted with key word(s) entered by Shipper (e.g., “minerals”)).

The Create FCL Shipment screen 902 may also include a section for the Shipper to indicate a price, or range of prices that the Shipper will accept in an offer. This data is preferably only available to Account Managers. Account Managers can use this data to manage the tender. In addition to these sections, the Create FCL Shipment screen 902 can include a Submit button 992 that is selected to transmit the shipping requirements data to the server of the service contract negotiation service provider 202.

Referring to FIG. 9c, the shipping requirement data for an auction can also be saved in the prior tender database 304a as a template that the Shipper 102 can recall for creating other tender line items. Consequently, the Create FCL Shipment screen 902 can include a Get Template section 993 from which the Shipper 102 can select a template from a pull-down, scrolling or pop-up menu or enter the template name in a data field. When the template is retrieved, the shipping requirement sections can be filled with the data stored in the template. The Create FCL Shipment screen 902 also may include a My Booking Frequency Rating hyperlink 994 that may be selected to view the Shipper's Booking Frequency Rating. The Booking Frequency Rating is determined by percentage of initiated tender line items that a Shipper has booked (i.e., accepted an offer) with a carrier. Additionally, the Create FCL Shipment screen 902 also may include a VIP Number section 995 for the Shipper to enter a VIP Number. The VIP Number is used for marketing purposes.

FIG. 9f illustrates a Request Confirmation screen 900f. When the Submit button 992 is selected the Request Confirmation screen 900f may be displayed on the web browser. Consequently, the Request Confirmation screen 900f comprises the tender line item 911, a Submit button 912, a Cancel button 913 and a Modify button 914. If the Submit button 912 is selected, a tender according to the tender line item is created. If the Cancel button is selected, the shipping requirements data can be deleted and the Shipper 102 can be returned to home (i.e., the Shipper screen 900b can be displayed on the web browser). If the Modify button 914 is selected, the Create FCL Shipment screen 902 (or Create less-than-container load (LCL) Shipment screen 904 or Create Service Contract screen 906) can be re-loaded on the web browser, with the shipping requirement data, so that the Shipper 102 can modify the shipping requirement data. The Request Confirmation screen 908 also may comprise a template name section 915 in which the Shipper may enter a name for the template that may be created when the Shipper 102 selects the Submit button 911. If the Shipper enters a template name in the template name section 915 the tender line item may be stored in the prior tender database 304a (or other location) under the template name. The Request Confirmation screen 908 is also displayed after the Submit button on a Create LCL Shipment screen 904a, 904b or 904a Create Service Contract screen 906b is selected.

FIG. 9b illustrates that when the Shipper selects the Submit button 911, and the auction is initiated, the web browser may display the Thank You screen 900g. The Thank You screen 900g may comprise a brief message thanking the Shipper 102 for creating a tender, informing the Shipper 102 of the tender number and that the pending tender will be reviewed by the Shipper's Account Manager and, if the Shipper 102 entered a template name, that a template was successfully created. If an Account Manager reviews the pending auction and approves it, the pending tender will become a live tender and the Shipper 102 may receive notification (e.g., by email, fax, phone, message on the Shipper screen 900b etc.) of the auction's new status.

FIGS. 9h and 9i illustrate the Create LCL Shipment screen 904a, 904b, respectively, that can be used to initiate a one-time LCL shipment auction and which is accessed through the corresponding hyperlink in the Shipper links 981 of the Shipper screen 900b. The Create LCL Shipment screen 904a, 904b is similar to the Create FCL Shipment screen 902 of FIGS. 9c-9e and can include many of the same sections, as shown in FIG. 9f. The Create LCL Shipment screen 904a, 904b does not include tender line item sections for container data (i.e., container type, flat rack dimensions, approx weight per container or number of containers), but instead can include shipping requirement sections 901 for package data: number of packages, package type, cubic volume, weight and temperature. This difference is sensible since the Create LCL Shipment screen 904a, 904b is for creating a less-than-container load shipment tender. Otherwise, the Create LCL Shipment screen 904a, 904b can be almost the same as the Create FCL Shipment screen 902 and it is used and processed in a similar manner.

FIGS. 9j-k illustrate the Create Service Contract screen 906a, 906b that can be used to initiate a service contract auction and which can be accessed through the corresponding hyperlink in the Shipper links 981 of the Shipper screen 900b. Likewise, the Create Service Contract screen 906 is similar to the Create FCL Shipment screen 902 of FIGS. 9c-e and comprises many of the same sections, as shown in FIGS. 9j-k. The Create Service Contract screen 906a, 906b comprises tender line item sections 911a that include a Start Date of Contract section and an End Date of Contract section. It is also noted that the Create Service Contract screen 906a, 906b comprises tender line item sections 911a for container data, since service contracts are generally for FCL shipments only. The Create Service Contract screen 906a, 906b may comprise tender line item sections 911a for package data, in order to enable service contract auctions for LCL shipments, but a need for LCL services contracts is extremely rare. Otherwise, the Create Service Contract screen 906a, 906b is almost the same as the Create FCL Shipment screen 902a-902c of FIGS. 9c, 9d, 9e and it is used and processed in a similar manner.

FIG. 9l illustrates the Request Confirmation screen 900g displayed after the tender line item(s) from a Create Service Contract screen 906a, 906b of FIGS. 9j, 9k are submitted (e.g., a Submit button on the Create Service Contract screen 906 is selected). The Request Confirmation screen 900g displayed in FIG. 9l is identical to the Request Confirmation screen 900f displayed in FIG. 9f, except that the tender line item displayed is for a Service Contract tender instead of a one-time FCL shipment.

FIG. 9m illustrates the View In Progress screen 900m, which is accessed through the corresponding hyperlink in the Shipper links 981 of the Shipper screen 900b. The View In Progress screen 900m comprises the activity table 983 and a Go to Tender section 984. On the View In Progress screen 900m, the activity table 983 comprises a list of hypertext tender numbers for the Shipper's pending and live (in progress) tenders. The activity table 983 may also comprise column headings 985, such as Date Opened, Close Date, Ship Week, Origin, Destination, # of Ctnrs (containers) and/or # of Offers. These column headings 985 indicate the shipping requirement data that is contained in the columns thereunder for each of the tenders in the list. The activity table 983 also may comprise Sort buttons 986 above some or all of the column headings 985. These Sort buttons 986 may be selected to sort, in ascending or descending order, the list of hypertext tender numbers based on the data in the column under the selected Sort button. For example, if the Sort button above the Date Opened column is selected, the list of hypertext tender numbers will be sorted in descending order based on the Date Opened of each tender. If the Sort button above the Date Opened column is selected again, the list of hypertext tender numbers will be sorted in ascending order based on the Date Opened of each tender.

Referring to FIG. 9m, note that tender #7634 in the activity table 983 states “Pending Approval” under the Date Opened and Date Closed column headings. This indicates that an Account Manager is or will be reviewing the tender line item for tender 7634. When the Account Manager completes reviewing the tender line item for tender 7634 and approves tender #7634, the Date Opened and Close Date for tender 7634 will be displayed. Likewise, note that tender #7632 states “Service Contract” under the Ship Week heading. This indicates that tender #7632 is a Service Contract tender, not a one-time shipment tender. Likewise, the “LCL” under the # of Ctnrs heading indicates that tender #7631 is a one-time LCL shipment tender, not a one-time FCL shipment auction.

The View Completed screen 907 (not shown), View Booked screen 900p (FIG. 9p) and View History screen 911 (not shown) are similar to the View In Progress screen 900m. These screens also comprise the activity table 983 and the Go to Tender section 984. However, the activity table 983 that is displayed in the View Completed screen 907 comprises a list of hypertext tender numbers for the Shipper's completed tenders; completed tenders are tenders which have past their close date and are closed for offers. Likewise, the activity table 983 that is displayed in the View Booked screen 900p comprises a list of hypertext tender numbers for the Shipper's booked tenders; booked tenders are auctions for which the Shipper has accepted a carrier's offer. Also, the activity table 983 that is displayed in the View History screen 911 comprises a list of hypertext tender numbers for the Shipper's prior tenders; prior tenders include the Shipper's completed and booked tenders for which the ship date is in the past.

FIGS. 9n1 and 9n2 illustrate the tender detail screen 900n1, 900n2, respectively that may be displayed on the web browser of Shipper 102 when the Shipper 102 selects a hypertext tender number or enters a tender number in the Go to Tender section 984. Tender detail screen 900n1, 900n2 may be displayed as a separate screen or as a part of the screen (e.g., a lower portion) from which the tender number was selected or entered. The tender detail screen 900n1, 900n2 comprises the tender line item 931 entered by the Shipper for the selected tender and a offers-submitted section 932 that includes any offers submitted for the selected tender and enables the Shipper to indicate acceptance of one of the submitted offers.

The offers-submitted section 932 may comprise an offer table 933, or other listing, of the offering carrier(s) 934, the corresponding offer(s) 935 and other related information. The offering carrier(s) 934 may be indicated by a hypertext name or number. An offering carrier's hypertext name or number may be selected to display a carrier rating of a carrier or other information about a carrier. The carrier rating, or other information about the carrier, may be displayed in pop-up window or similar section. The corresponding offer(s) may comprise a price (e.g., price per container if a one-time FCL shipment or service contract) and price components (e.g., indicated by acronym or other abbreviation). The offers-submitted section 932 may also comprise a price components acronyms section 936 (and possibly a currency acronym section) that provides the meanings of various price components. The offers may also comprise logistics information such as a transit time for the shipment and an indication of whether rail will be used for each offer. The Shipper may consider all of the information described above in selecting an offer.

Additionally, the offer table 933 may comprise a check-circles) 937, or other section, for the Shipper to indicate acceptance of an offer and a Accept Offer button to enter this acceptance. As stated above, the Shipper generally considers the price, the price components and the transit time, as well as some or all of the related information (including Service Provider brand and logistics), in choosing an offer.

FIG. 9o illustrates a Thank-You screen 900o that may be displayed on the Shipper's web browser when the Shipper accepts an offer and transmits the acceptance to the service contract negotiation service provider 202.

FIG. 9p illustrates the View Booked screen 900p and the offers-submitted section 932 of a tender detail screen 900n after an offer has been accepted (after “booking”). The activity table 983 comprises hypertext tender numbers for the booked tenders and related information (e.g., tender opened date, booked date, shipment week (SVC if a service contract), origin, destination, number of containers (LCL if less than container) and number of offers).

Further, as shown in FIG. 9p, the winning or accepted offer may be highlighted or otherwise indicated in the offers-submitted section 932.

FIG. 9q illustrates a Feedback screen 900q that may be accessed by selecting the hypertext tender number of a booked tender from the activity table 983 on the View History screen 911. The Feedback screen 900q allows the Shipper to provide feedback to the service contract negotiation service provider 202 about the carrier's performance on a booked one-time shipment or service contract. The Feedback screen may comprise a feedback form 941, which includes various criteria and check-circles or other section for indicating the level of satisfaction with regards to the associated criteria, and a Submit button 942. When the Shipper completes the feedback form 941 and selects the Submit button 942, the feedback is transmitted to the server of the service contract negotiation service provider 202.

FIG. 9r comprises a Templates screen 900r, which may be accessed by selecting the corresponding Shipper link 981. The Templates screen 900r comprises hypertext template name(s) 951 that correspond to tender templates that have been previously saved by the Shipper and stored at the server of the service contract negotiation service provider 202a-202c. Relevant information, such as origin, destination and number of containers for each template, may also be included. Likewise, the screen may include delete checkboxes or similar sections which may be selected to delete a template. Deletion of a template will remove the template from the prior tender database 304a, or from whatever location where it was stored.

FIG. 9s comprises a Refer a Colleague screen 900s. The Refer a Colleague screen 900s may comprise sections for entering a colleague's email address, a return email address and a message to the colleague regarding the service contract negotiation service provider 202, and a Submit button. When the user selects the Submit button, the message will be sent to the colleague's email address, with the return email address being listed as the sender. A link to a web site of the service contract negotiation service provider 202 may be included with the message so that the colleague may easily access the service contract negotiation service provider 202.

FIGS. 10a-10m illustrate some of the screens that may be accessed by a carrier. Some screens accessible to a carrier are identical or similar to screens of the same name that are accessible to Shippers. Accordingly, these screens are not re-described below. FIG. 10a illustrates the Carrier screen 1000a. The Carrier screen 1000a comprises carrier links 1001, tabbed links 1002, an activity table 1003 and a Go To Tender section 1004. The carrier links 1001 comprise hyperlinks to various screens that the carrier can access. By selecting these hyperlinks, the carrier can access the associated screens. Among the carrier links 1001 may be a link to a Favorites screen (not shown) that comprises live tenders that meet certain criteria that the carrier has set (i.e., the Service Provider's favorite tenders) and for which the carrier has not yet submitted an offer.

The activity table 1003 may comprise a list of hypertext tender numbers for live (in progress) tenders in which the carrier has pending offers. The activity table 1003, which is similar to the activity table 983, may comprise columns corresponding to various tender details, such as tender number, date opened, close date, shipment week, origin, destination, number of containers and number of offers. Likewise, as discussed above, the carrier can select one of the hypertext tender numbers from the activity table 1003 to access the carrier tender detail screen 900n′ (not shown) for the selected tender, the carrier tender detail screen being essentially the same as the Shipper's tender detail screen 900n as described above with reference to FIG. 9n except the information displayed in the carrier tender detail screen 900n ′ is tailored for the carrier instead of the Shipper. It is noted that other screens accessible from the Carrier screen 1000a may also comprise the carrier links 1001, the tabbed links 1002, the activity table 1003 and/or the Go To Tender section 1004.

FIG. 10b depicts the View All Requests screen 1000b, which may be accessed by selecting the associated hyperlink from the carrier links 1001. The View All Requests screen 1000b comprises an activity table 1003 with hypertext tender numbers for all tenders that are live (open for accepting offers) in the service contract negotiation service provider 202. Since there may be many live tenders, the activity table 1003 may include or cover multiple pages. Accordingly, the activity table 1003 may further comprise a section for displaying other pages, such as hypertext: numbers corresponding to each page, next arrows for moving to the succeeding or preceding page and/or a last page hypertext for moving to the last page of the activity table 1003. As with the activity table 1083 of the View In Progress 900m (see FIG. 9l), the activity table 1003 may also comprise sortable tender detail columns. Additionally, the View All Requests screen 1000b may comprise a Go To Tender section 1004. Consequently, the carrier may access a live tender listed on the View All Requests screen 1000b by selecting a corresponding hypertext tender number in the activity table 1003 or by entering the corresponding tender number in the Go To Tender section 1004 or directly from an email in its mailbox.

FIG. 10c comprises the Search By Trade Route screen 1000c, which may be accessed by selecting the associated hyperlink from the carrier links 1001. The Search By Trade Route screen 1000c comprises a trade route section 1021 that allows the carrier to select a trade route with which to filter the pending tenders displayed on the View All Requests screen 1000b. For example, if the carrier selects a Transpacific Eastbound trade route (e.g., because the carrier has an un-booked cargo ship returning from a Transpacific Westbound shipment), the View All Requests screen 1000b will be displayed only with pending tenders for Transpacific Eastbound one-time shipments and if the carrier is an ocean carrier, their view may include service contracts. The trade route section 1021 may comprise a pull down, scrolling or pop-up menu, from which the carrier may select or highlight the desired trade route, and a submit button which the carrier may select to enter the trade route selection.

FIG. 10d illustrates the Search By Selected Criteria screen 1000d, which may be accessed by selecting the associated hyperlink from the carrier links 1001. The Search By Selected Criteria screen 1000d comprises one or more criteria sections 1031 in which the carrier may specify criteria with which to filter the live tenders displayed on the View All Requests screen 1000b. For example, if the carrier specifies LCL Shipments (e.g., because the carrier has some partially unfilled containers on numerous shipments), the View All Requests screen 1000b will be displayed only with pending tenders for one-time LCL shipments. The one or more criteria sections 1031 may comprise pull-down scrolling or pop-up menus, check-boxes, data-fields or other sections and a submit button for entering or specifying the one or more criteria with which the carriers desires to filter the live tenders. The one or more criteria may comprise, for example, transaction type (FCL shipments, LCL shipments or service contracts), shipments posted within the last x days, shipments closing within the next x hours, auctions where start date/shipment departure falls between x date and y date, origin of shipment, destination of shipment, one or more trade routes, shipments of x to y number of containers, one or more container types, commodity group and/or number of bids less than x.

FIG. 10e illustrates the carrier tender detail screen 1000e, which may be accessed by selecting a hypertext tender number or entering the tender number. As with the tender detail screen 900n accessed by a Shipper 102, the carrier tender detail screen 1000e comprises a tender line item 1031 and a offers-submitted section 1032 for the selected tender and a Make an Offer section 1038. Unlike the offers-submitted section 1032 displayed on tender detail screens 900n to Shippers 102, the offers-submitted section 1032 on the carrier tender detail screen 1000e does not include the identities of the offering carriers 104 (except for the identity of the carrier viewing the tender detail screen 1000e if that carrier submitted an offer for the tender line item). In other words, the service contract negotiation service provider 202 keeps the offering carrier's identities secret or anonymous so that other carriers cannot determine their offering tendencies and the like.

Referring again to FIG. 10e, the carrier tender detail screen 1000e may also comprise Add to Favorites 1039, Shipper Booking Frequency 10310, Other Requests 10311 and Shipper Feedback 10312 hyperlinks. The Add to Favorites hyperlink 1039 may be selected to add the selected tender to the carrier's Favorites. If a tender is added to the carrier's Favorites, the carrier may access the added tender by selecting the Favorites hyperlink from the carrier links 3201 (see below). The Shipper Booking Frequency 10310 may be selected to access the Shipper Booking Frequency screen 1000f, which is illustrated in FIG. 10f. The Shipper Booking Frequency screen 1000f comprises the Shipper's (i.e., the Shipper that initiated the selected tender) booking frequency rating, which may be based on the number of shipments booked compared to the total number of tenders initiated by that Shipper. The Shipper's booking frequency rating may be indicated as being either New (not rated), Low, Medium or High. The Other Requests hyperlink 10311 is selected to access a View All Requests screen 1000b comprising all of the Shipper's open tenders. The Shipper Feedback hyperlink 10312 may be selected to access feedback from the Shipper regarding the carrier.

Referring to FIG. 10e, the Make an Offer section 1038 allows the carrier to submit and offer on the selected tender line item. The Make an Offer section 1038 may comprise data fields, pull-down, scrolling or pop-up menus, check-boxes, check-circles, a Submit button and/or other sections for entering the price (e.g., total price or price per container), currency, price components, transit time and indicating whether rail is used or not. For example, for the LCL shipment illustrated in FIG. 10e, the carrier may enter a total price in a data field, select the currency from a pull-down menu, check the price component(s) (e.g., Ocean Freight Charge) indicating what the price includes, enter a transit time in a data field, indicate no rail in a check-circle and select the Submit button. This will cause the carrier's offer to be transmitted to the server of the service contract negotiation service provider 202, stored in offer database 204b (or other location), and added to the offers-submitted section 1032 of the tender detail screens 900n and 1000e corresponding to the selected tender line item. If a confirmation screen is displayed, the offer may not be transmitted until the offer is confirmed by selecting a Submit button on the confirmation screen.

FIG. 10f illustrates a shipper booking frequency section 10315 superimposed on the tender detail screen 1000e. The shipper booking frequency section 10315 provides the booking frequency, as expressed from a range of new, low, medium or high, of the shipper that initiated the tender shown in the tender detail screen 1000e.

FIG. 10g illustrates the Make a Bid section 1038 of a tender detail screen 1000g for a service contract. In comparison to the Make an Offer section 1038 for a LCL shipment seen in FIG. 10e, it is noted that the Make an Offer section 1038 in FIG. 10g also comprises data fields or sections for penalty per container, minimum number of containers per voyage and number of voyages per month. Service Contracts generally require a minimum number of containers per voyage and specify a number of voyages per month. The penalty per container, if any, is the penalty the carrier will charge if the minimum number is not met. Furthermore, the data field or section for price requests Price per container as opposed to Total Price. It is noted that the Make an Offer section 1038 illustrated in FIG. 10g has been filled out and is a complete offer awaiting submittal to the server of the service contract negotiation service provider 202.

When an offer entered in the Make an Offer section 1038 of a tender detail screen 1000g of FIG. 10g is submitted, an Offer Confirmation screen 1000h is displayed on the carrier's web browser, as seen in FIG. 10h. The Offer Confirmation screen 1000h comprises the carrier's offer 1071, including price, price components, and other appropriate related information, such as Penalty per container, Number of containers per voyage, Number of voyages per month, Transit Time in Days and whether Rail is used or not. Certain types of information, such as penalty per container, number of containers per voyage and number of voyages per month, are irrelevant to certain tenders (e.g., for LCL or FCL shipment tenders). The Offer Confirmation screen may further comprise a Submit button 1072 to confirm the offer and a Modify this offer hyperlink 1073 to re-access the Make an Offer section 1038 of the tender detail screen 1000e in order to modify the offer. FIG. 10i (not shown) illustrates a Thank You screen 1000i displayed on the carrier's web browser when the offer is submitted to the server of the service contract negotiation service provider 202.

The carrier may select a View Won hyperlink from the carrier links 1001 in order to access the View Won screen 1002. The View Won screen 1002 (not shown) comprises an activity table 1003 that includes the hypertext tender numbers for tenders in which a Shipper accepted the carrier's offer. If the carrier selects a hypertext tender number from the activity table 1003 (or enters the tender number in a Go To Tender section), the tender detail screen 1000e for the selected won tender is displayed on the carrier's web browser, as illustrated in FIG. 10j. As seen in FIG. 10j, the tender detail screen 1000e comprises the offers-submitted section 3432 in which the carrier's winning offer is highlighted or otherwise indicated. In the example shown in FIG. 10j, the carrier's winning offer had the same price as one of the losing offers (i.e., 2100 USD per container). However, the carrier's winning offer included a shorter transit time (i.e., 29 days vs. 34 days) and more voyages per month.

The View History screen 1004 (not shown), accessible from the corresponding hyperlink of the carrier links 1001, comprises an activity table 1003 that includes hypertext tender numbers for tenders that the carrier won and has completed performance on the associated one-time shipment or service contract. The tender detail screens 1000e, which are accessible by selecting the hypertext tender numbers of these tenders, includes a Shipper Feedback hyperlink 10312.

FIG. 10k illustrates a Shipper Feedback screen 1000k that may be accessed by selecting the Shipper Feedback hyperlink 10312. The Shipper Feedback screen 1000k comprises the Shipper's rating of the carrier's performance on the associated one-time shipment or service contract. An email requesting Feedback from the Shipper may be automatically sent to the Shipper after a shipment is completed.

FIG. 10l illustrates the Access Favorites screen 1000l that may be accessed by selecting the corresponding hyperlink of the carrier links 1001. The Access Favorites screen 1000l comprises an activity table 1003 that includes hypertext tender numbers for tenders that the carrier has added to the carrier's Favorites (see above). The Access Favorites screen 1000l may also comprise a delete section 1071 that may be selected to delete a hypertext tender number from the activity table.

FIG. 10m illustrates the Access Automatic Alerts screen 1000m that may be accessed by selecting the corresponding hyperlink of the carrier links 1001. The Access Automatic Alerts screen 1000m allows the carrier to setup one or more criteria that trigger alerts, via email, fax, etc., of newly initiated auctions. The Access Automatic Alerts screen 1000m, therefore, may comprise a criteria section 1001 with which the carrier may select one or more criteria that are used to filter newly initiated tenders, a frequency section 1002 with which the carrier may select the frequency of the alerts and a method section 1003 with which the carrier may select the method for the service contract negotiation service provider 202 to communicate the alert (e.g., via fax or email). Each of these sections may comprise pull-down, scrolling or pop-up menus, check-boxes or check-circles, data fields or other sections. For example, the carrier may select All Trade Routes, All Commodity Groups and All Container Types as the criteria, a frequency of sending a separate message for every new shipment matching my selected criteria and a method of email. Any initiated tender for any trade route, any commodity group and any container type will trigger a separate email message, sent by the server of the service contract negotiation service provider 202 to a user machine of the carrier. Alternatively, if the carrier were to select Transpacific Westbound, the server service contract negotiation service provider 202 will send a separate email message only for every initiated tender for a Transpacific Westbound shipment or service contract.

An NVOCC member of the service contract negotiation service provider 202 can access screens accessible to Shippers and carriers. From the Shipper screens, the NVOCC member may access all screens relating to service contracts. Likewise, the NVOCC member may access all carrier screens not relating to service contracts. The NVOCC member, however, may not create a one-time FCL or LCL shipment tender. Therefore, the NVOCC member may not access the Create FCL Shipment screen 902 or Create LCL Shipment screen 904.

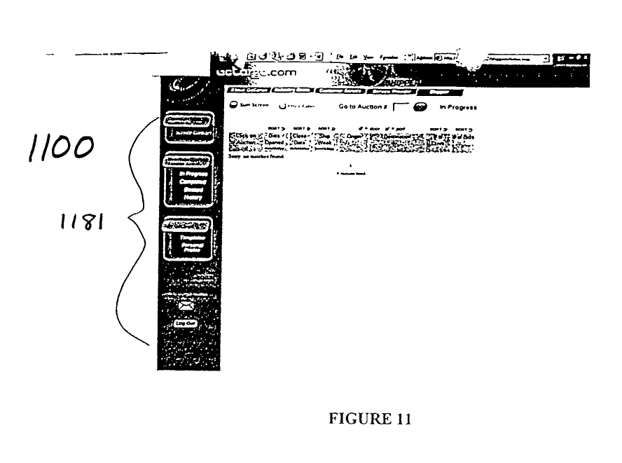

Accordingly, as illustrated in FIG. 11, the Shipper Links 1181 of the Shipper screen 1100 and other screens accessed by the NVOCC member from the Shipper screen 1100 (i.e., the Create Service Contract screen 906, View In Progress screen 900m, View Completed screen 907, etc.) do not include hyperlinks corresponding to the Create FCL Shipment screen 902 or Create LCL Shipment screen 904. The Shipper Links 1181 do include a hyperlink corresponding to the Create Service Contract screen 906. Otherwise, as seen in FIG. 11, the Shipper Links 1181 and the other portions of the screens accessed from the Shipper screen 1100 by the NVOCC member are the same as those accessed by a Shipper. Similarly, the carrier screen 1000a and the screens accessed by the NVOCC member from the carrier screen 1000a are the same as those accessed by a carrier.

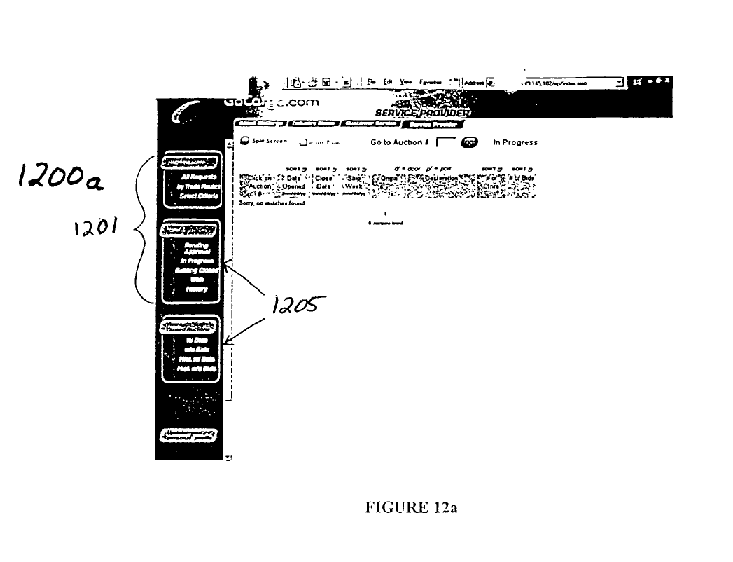

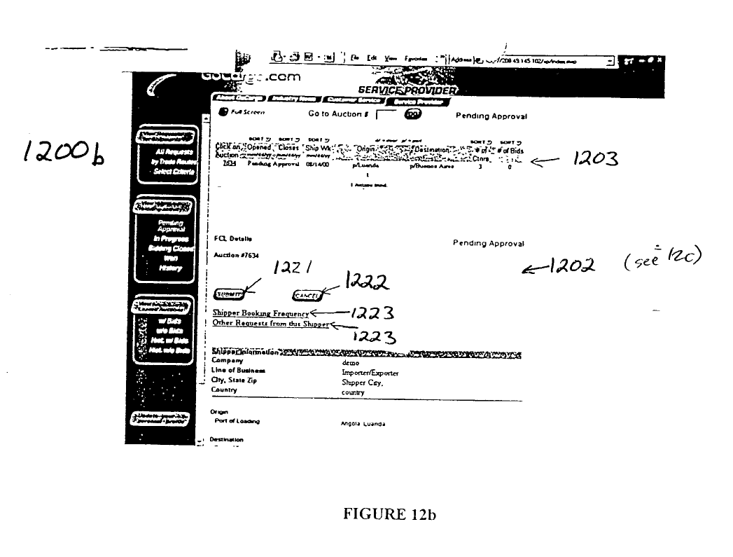

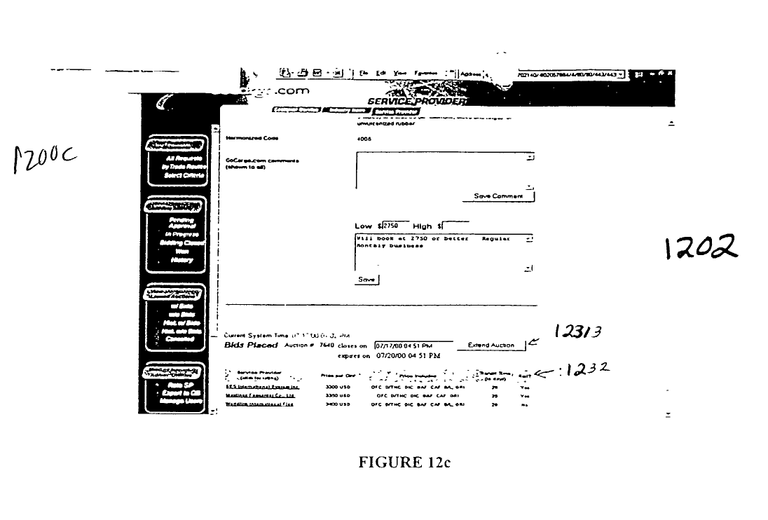

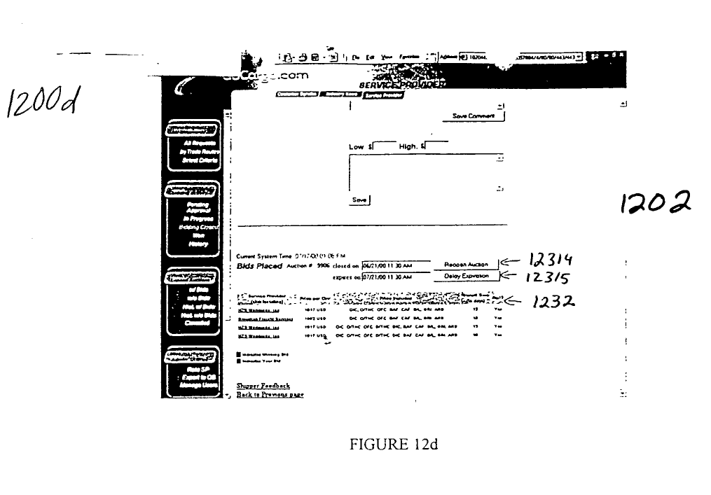

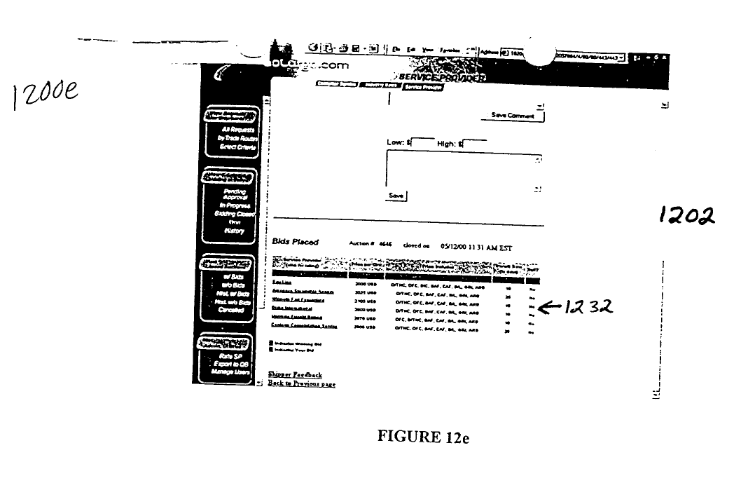

FIGS. 12a-12e illustrate some of the screens that may be accessed by an Account Manager. As noted above, a registered Account Manager can access the carrier screen 1200a, and the screens accessible from the carrier screen 1200a, after logging-on to the service contract negotiation service provider 202. Furthermore, the Account Manager may access a number of additional screens, as discussed above. As illustrated in FIG. 12a, the carrier screen 1200a, and the screens accessible from the carrier screen 1200a, when accessed by the Account Manager comprise Account Manager links 1205 in addition to at least some of the carrier links 1201. The Account Manager links 1205 comprise hyperlinks to the screens accessible only to the Account Manager from the carrier screen 1000a. For example, the Account Manager links 1205 may comprise hyperlinks to the View Pending Approval screen 1200b, the View Lapsed Tenders w/Offers screen, the View Lapsed Tenders w/o Offers screen, the View Lapsed Tenders Historic w/Offers screen, the View Lapsed Tenders Historic w/o Offers screen, the View Cancelled Tenders screen, the Rate carrier screen, the Quickbooks Export screen and the User Management screen (not shown).

FIG. 12b depicts the View Pending Approval screen 1200b, that may be accessed by selecting the corresponding hyperlink of the Account Manager links 1205, and a portion of an Account Manager tender detail screen 1202 for a pending approval tender. The View Pending Approval screen 1200b may comprise an activity table 1203 that includes hypertext tender numbers for tenders that have been submitted by a Shipper and which are awaiting the Account Manager's approval. The Account Manager may select the hypertext tender number of a pending approval tender, review the tender line item displayed on the tender detail screen 1202 of the selected tender and select a Submit button 1221 or a Cancel button 1222 on the tender detail screen 1202 or View Pending Approval screen 1200b to indicate approval or disapproval of the tender. As seen in FIG. 12b, the tender detail screen 1202 or View Pending Approval screen 1200b may comprise a Shipper Booking Frequency link 1223 and an Other Requests from this Shipper link 1224 which the Account Manager may select to view the Shipper's booking frequency or other requests (tenders). The Account Manager may disapprove of a tender line item based on the Shipper's booking frequency or because the tender line item is similar to other tender line items that the Shipper has submitted. Likewise, the Account Manager may disapprove of a tender because the tender line item is missing a necessary component. Under these circumstances, the Account Manager is acting as an Account Manager for the Shipper. When and if the Account Manager approves the tender and selects the Submit button, the tender will be included on the View All Requests screen 1000b with its open and close dates listed.

The View Pending Approval screen 1200b or the tender detail screen 1202 of a pending approval tender may include a section (not shown) for the Account Manager to set a close date for the tender that is earlier than the tender expiration date set by the Shipper. As noted above, this allows the Account Manager to better control the tender.

FIG. 12c illustrates a bottom portion 1200c of a tender detail screen 1202 accessed by an Account Manager selecting a hypertext tender number from the activity table 1203 on the View In Progress screen 900m. The offers-submitted section 1232 shown comprises an Extend Tender section 12313 that enables the Account Manager to extend the pending tender beyond the close date. The Extend Tender section 12313 may include a data field for entering a new close date and an Extend Tender button for submitting the new close date. When the Account Manager selects the Extend Tender button, the selected tender's Close Date will be changed accordingly on the View All Requests screen 1000b and View In Progress screen 900m.

FIG. 12d illustrates a bottom portion 1200d of an tender detail screen 1202 accessed by an Account Manager selecting a hypertext tender number from the activity table 1203 on the View Closed screen (not shown). The offers-submitted section 1232 shown comprises a Reopen Tender section 12314 and a Delay Expiration section 12315. The Reopen Tender section 12314 enables the Account Manager to reopen a tender that has closed (i.e., it has past the Close Date). Likewise, the Delay Expiration section 12315 enables the Account Manager to delay expiration of a tender by extending the tender expiration date. If a tender is reopened, it will be re-listed on the View All Requests screen 1000b and View In Progress screen 900m.

FIG. 12e illustrates a bottom portion 1200e of tender detail screen 1202 accessed by an Account Manager selecting a hypertext tender number from the activity table 1203 on the View Won screen 1002 or View History screen 1004. The bottom portion includes the offers-submitted section 1232, which comprises the offers submitted on the selected tender, with highlighting or other indication of the winning offer. As seen from FIG. 12e, and unlike the offers-submitted section 1232 of tender detail screens 1000e accessed by carriers, the offers-submitted section 1232 of an tender detail screen 1202 accessed by the Account Manager does include the identities of the clients that submitted offers. In other words, the identities of the carriers submitting offers are not kept anonymous from the Account Manager. Other screens accessible to the Account Manager, include, e.g., the View Lapsed Tenders w/Offers screen, the View Lapsed Tenders w/o Offers screen, the View Lapsed Tenders Historic w/Offers screen, the View Lapsed Tenders Historic w/o Offers screen and the View Cancelled Tenders screen (all not shown), also provide access through hypertext tender numbers to tender details screens 1202 that include the identities of carriers submitting offers.

It is again noted that the above-described screens are exemplary and are not meant to limit the scope of the method or system of the present invention. For example, the present invention also encompasses split screens that include an activity table and details of a selected tender from the activity table.

It is also noted that the invention comprises a notification system that is described in various sections above. The notification system may send notices via numerous communication mediums, such as email, fax, phone and screens (e.g., messages on a member's Shipper screen or carrier screen). The notices may comprise real-time, hourly, daily, etc. messages to carriers alerting them to newly pending auctions that meet criteria they have set to trigger notification. The messages may include direct links to the tender(s) that are the subject of the notice. These links allow the carrier to directly access the tender detail screen of the linked tenders. Accordingly, these links provide for a quicker, direct access than navigating to the tender through a web browser.

While the present invention has been described in connection with an exemplary embodiment, it will be understood that many modifications will be readily apparent to those skilled in the art, and this application is intended to cover any adaptations or variations thereof. For example, different screens, screen sections, reports hardware and methods may be used without departing from the scope of the invention. This invention should be limited only by the claims and equivalents thereof.

What is claimed is:

1. A method for negotiating a service contract online via a service contract negotiation online service provider, comprising the steps of:
(a) receiving one or more tender line items from a shipper and storing said one or more tender line items in a tender database;
(b) providing online viewing access of said tender database to one or more carriers;
(c) receiving an offer from each of said one or more carriers and storing offers received from said one or more carriers in an offer database;
(d) providing online viewing access of said offers received from said offer database to said shipper;
(e) receiving one or more final designations of awarded line items from said shipper designating one or more winning carriers; and
(f) communicating said one or more final designations of awarded line items corresponding to one or more awarded service contracts.

2. The method according to claim 1, wherein each of said one or more tender line items comprises an origin, a destination, and a container size of a container.

3. The method according to claim 2, wherein each of said one or more tender line items further comprises at least one of a route and a commodity.

4. The method according to claim 2, wherein said container comprises an ocean container.

5. The method according to claim 1, further comprising the steps of:
(g) receiving a list of one or more tentative award carriers designated by said shipper; and
(h) receiving at least one revised offer from said one or more tentative award carriers.

6. The method according to claim 1, wherein said step (b) comprises:
(1) allowing filtering of views of said one or more tender line items.

7. The method according to claim 1, wherein said one or more tender line items further comprise at least one of: an origin, a destination, a container size, a commodity, volume information for a period of time, a route, and a type of service.

8. The method according to claim 1, wherein said offer comprises at least one of: a price and a route.

9. The method according to claim 8, wherein said offer further comprises a time frame.

10. The method according to claim 8, wherein said route comprises at least one of a method of service, a quality of service, and a mode of transportation.

11. The method according to claim 10, wherein said mode of transportation comprises at least one of: ocean transport, land transport, and air transport.

12. The method according to claim 11, wherein said land transport comprises at least one of: rail transport, truck transport, and barge transport.

13. The method according to claim 1, wherein said step (f) further comprises:
(1) communicating said one or more final designations of awarded line items to designated users of information comprising at least one of: personnel from warehouses, personnel from shipping sites, personnel from carrier sites, personnel from manufacturing plants, and selected third parties.

14. The method according to claim 13, wherein said selected third parties comprise freight forwarders, consolidators, third party logistics, and accountants.

15. The method according to claim 1, wherein the method further comprises:
(g) monitoring for exceptions including tracking actual bookings;
(h) comparing actual bookings to said one or more final designations of awarded line items;
(i) identifying a variance between said actual bookings and said one or more final designations of awarded line items; and
(j) reporting said variance.

16. The method according to claim 15, wherein said step (h) comprises comparing a booked container quantity to a committed container quantity.

17. The method according to claim 15, wherein said step (i) comprises:
(1) determining whether said variance exceeds a variance threshold.

18. The method according to claim 15, wherein said step (j) comprises:
(1) notifying appropriate parties at shipper of said variance.

19. The method according to claim 18, wherein the appropriate parties are notified through electronic means.

20. The method according to claim 19, wherein said electronic means comprises at least one of an online application, an email, a facsimile, a computing device, a communications device, a handheld messaging device, and a message.

21. The method according to claim 1, wherein the method further comprises:
(g) receiving confirmation that said one or more winning carriers has completed appropriate regulatory actions.

22. A method for negotiating a service contract comprising:
(a) receiving a tender line item from a shipper and an offer from a carrier;
(b) providing online viewing access to said tender line item and said offer;
(c) receiving a designation of a selected offer associated with said tender line item; and
(d) communicating said designation.

23. The method according to claim 1, wherein the method further comprises:
(g) reporting actual volume of cargo moved against said service contract.

24. The method according to claim 1, wherein the method further comprises:
(g) reporting actual line items moved in said service contract.

25. The method according to claim 1, wherein the method further comprises:
(g) reporting actual line items moved outside said service contract.

26. The method according to claim 1, wherein the method further comprises:
(g) reporting actual service performance of carriers against agreed upon service performance.

27. The method according to claim 1, wherein the method further comprises:
(g) providing an automated booking process by allowing shipper to place a booking against a contract line item of said service contract.
